(19) United States
(12) Patent Application Publication
(10) Pub. No.: US 2020/0177957 A1
(43) Pub. Date: Jun. 4, 2020

(54) FIRST NODE, SECOND NODE, THIRD NODE, AND METHODS PERFORMED THEREBY, FOR HANDLING DIGITAL MEDIA CONTENT

(71) Applicant: Telefonaktiebolaget LM Ericsson (publ), Stockholm (SE)

(72) Inventors: Konstantinos VANDIKAS, Solna (SE); Lackis ELEFTHERIADIS, Gävle (SE); Athanasios KARAPANTELAKIS, Solna (SE); Maxim TESLENKO, Sollentuna (SE); Keven WANG, Sollentuna (SE)

(73) Assignee: Telefonaktiebolaget LM Ericsson (publ), Stockholm (SE)

(21) Appl. No.: 16/633,453

(22) PCT Filed: Jul. 25, 2017
(86) PCT No.: PCT/SE2017/050794

§ 371 Date: Jan. 23, 2020

(51) Int. Cl. H04N 21/442; H04N 21/234; H04N 21/233; H04N 21/44; H04N 21/439; H04N 21/436; H04N 21/45

(52) U.S. Cl. CPC H04N 21/44222; H04N 21/23418; H04N 21/233; H04N 21/4532; H04N 21/4394; H04N 21/43615; H04N 21/44008

(57) ABSTRACT

Method performed by a first node (101). The method is for handling a digital media content. The first node (101) determines (203), automatically, a segment of the digital media content to be of interest to a first user of a second node (102) providing the digital media content to the first user. The determining (203) is based on an analysis of collected data on seeking of the digital media content by at least one second user. The seeking has been performed in points in time in the digital media content. The points in time have been freely chosen by the least one second user from an entire duration of the digital media content. The first node (101) then initiates (204) providing a first indication of the determined segment of the digital media content to be of interest to the first user, to at least one of: the second node (102), and another node (103, 104).

### TECHNICAL FIELD

The present disclosure relates generally to a first node and methods performed thereby for handling digital media content. The present disclosure also relates generally to a second node, and methods performed thereby for handling digital media content. The present disclosure additionally relates generally to a third node, and methods performed thereby for handling digital media content. The present disclosure further relates generally to a computer program product, comprising instructions to carry out the actions described herein, as performed by the first node, the second node, or the third node. The computer program product may be stored on a computer-readable storage medium.

### BACKGROUND

Computer systems may comprise one or more nodes. A node may comprise one or more processors which, together with computer program code may perform different functions and actions, a memory, a receiving and a sending port. Nodes may be comprised in a telecommunications network.

Nodes within a telecommunications network may be wireless devices, e.g., stations (STAs), User Equipments (UEs), mobile terminals, wireless terminals, terminals, and/or Mobile Stations (MS). Wireless devices are enabled to communicate wirelessly in a cellular communications network or wireless communication network, sometimes also referred to as a cellular radio system, cellular system, or cellular network. The communication may be performed e.g. between two wireless devices, between a wireless device and a regular telephone, and/or between a wireless device and a server via a Radio Access Network (RAN), and possibly one or more core networks, comprised within the telecommunications network. Wireless devices may further be referred to as mobile telephones, cellular telephones, laptops, or tablets with wireless capability, just to mention some further examples. The wireless devices in the present context may be, for example, portable, pocket-storable, hand-held, computer-comprised, or vehicle-mounted mobile devices, enabled to communicate voice and/or data, via the RAN, with another entity, such as another terminal or a server.

The telecommunications network may cover a geographical area which may be divided into cell areas, each cell area being served by another type of node, a network node or Transmission Point (TP), for example, an access node such as a Base Station (BS), e.g. a Radio Base Station (RBS), which sometimes may be referred to as e.g., evolved Node B (“eNB”), “eNodeB”, “NodeB”, “B node”, or BTS (Base Transceiver Station), depending on the technology and terminology used. The base stations may be of different classes such as e.g. Wide Area Base Stations, Medium Range Base Stations, Local Area Base Stations and Home Base Stations, based on transmission power and thereby also cell size. A cell is the geographical area where radio coverage is provided by the base station at a base station site. One base station, situated on the base station site, may serve one or several cells. Further, each base station may support one or several communication technologies. The telecommunications network may also be a non-cellular system, comprising network nodes which may serve receiving nodes, such as wireless devices, with serving beams.

In 3rd Generation Partnership Project (3GPP) Long Term Evolution (LTE), base stations, which may be referred to as eNodeBs or even eNBs, may be directly connected to one or more core networks. All data transmission in LTE is controlled by the radio base station.

The standardization organization 3GPP is currently in the process of specifying a New Radio Interface called NR or 5G-UTRA, as well as a Fifth Generation (5G) Packet Core Network, which may be referred to as Next Generation Core Network, abbreviated as NG-CN, NGC or 5G CN.

Identifying interesting parts of a media stream is well researched in the state of art. One of the existing approaches of doing so is the introduction of metadata in the media stream that define so-called “chapters” in the media stream. The chapters may be understood as specific points in the timeline of the media stream, where a user may skip to. Many existing file formats of digital audio or video content such as Microsoft's WMA and AVI, Adobe's Flash, Matroska MKV, MPEG-4, MXF, Apple's QuickTime, etc. support such a feature by use of metadata. Similarly, in audio streams, there exist similar formats which support “chapter” functionality. One example of such a format is version 2 standard of the ID3 format, which may be used in conjunction with the MPEG-3 audio standard [1]. Existing methods are drawn to automation in identifying interesting fixed or pre-defined parts in media streams, e.g., “chapters”. Many approaches use artificial intelligence for video analysis, e.g., using Bayesian topic models [2][3] and Machine learning [4] to identify pre-defined parts a user may consider interesting.

The current methods of automated detection of “interesting” areas in videos, however, may require an a-priori training of what a machine should consider “interesting”, they are characterized by being computationally heavy and error-prone.

### SUMMARY

It is an object of embodiments herein to improve the handling of digital media content in a computer system.

According to a first aspect of embodiments herein, the object is achieved by a method, performed by a first node. The method is for handling a digital media content. The digital media content comprises at least one of: digital audio and digital video. The first node is comprised in a computer system. The first node determines, automatically, a segment of the digital media content to be of interest to a first user of a second node. The second node provides the digital media content to the first user. The second node is comprised in the computer system. The determining is based on an analysis of collected data on seeking of the digital media content by at least one second user. The seeking has been performed in points in time in the digital media content. The points in time have been freely chosen by the least one second user from an entire duration of the digital media content. The first node then initiates providing a first indication of the determined segment of the digital media content to be of interest to the first user, to at least one of: the second node, and another node comprised in the computer system.

According to a second aspect of embodiments herein, the object is achieved by a method, performed by a second node. The method is for handling the digital media content. The digital media content comprising at least one of: digital audio and digital video. The second node is comprised in a computer system. The second node collects data from the first user of the second node on seeking the digital media content. The data comprises a) a first point in time a playback of the digital media content by the first user started, wherein the first point in time was freely chosen by the first user from an entire duration of the digital media content. The data also comprises b) a second point in time the playback of the digital media content by the first user ended, wherein the second point in time was freely chosen by the first user from the entire duration of the digital media content. The second node then initiates providing a second indication of the collected data to at least one of: the first node comprised in the computer system, and another node comprised in the computer system.

According to a third aspect of embodiments herein, the object is achieved by a method, performed by a third node. The method is for handling the digital media content. The digital media content comprises at least one of: digital audio and digital video. The third node is comprised in the computer system. The third node receives, from the first node comprised in the computer system, the first indication of the segment of the digital media content determined to be of interest to the first user of the second node providing the digital media content to the first user. The second node is comprised in the computer system. The segment of the digital media content has been determined to be of interest based on the analysis of collected data on seeking of the digital media content by the at least one second user. The points in time have been freely chosen by the least one second user, from the entire duration of the digital media content. The third node initiates providing, on an interface of the third node, the third indication of the segment of the digital media content determined to be of interest to the first user, based on the received first indication.

According to a fourth aspect of embodiments herein, the object is achieved by the first node, configured to handle the digital media content. The digital media content comprises at least one of: digital audio and digital video. The first node is configured to be comprised in the computer system. The first node is further configured to determine, automatically, the segment of the digital media content to be of interest to the first user of the second node. The second node is configured to provide the digital media content to the first user and to be comprised in the computer system. To determine is configured to be based on the analysis of data configured to be collected, on seeking of the digital media content by the at least one second user. The seeking is configured to have been performed in points in time in the digital media content, the points in time being configured to have been freely chosen by the least one second user from the entire duration of the digital media content. The first node is further configured to initiate providing the first indication of the segment of the digital media content configured to be determined to be of interest to the first user, to at least one of: the second node, and the another node configured to be comprised in the computer system.

According to a fifth aspect of embodiments herein, the object is achieved by the second node, configured to handle the digital media content The digital media content comprises at least one of: digital audio and digital video. The second node is configured to be comprised in the computer system. The second node is further configured to collect data from the first user of the second node on seeking the digital media content. The data comprises a) the first point in time the playback of the digital media content by the first user is configured to have started. The first point in time is configured to have been freely chosen by the first user from the entire duration of the digital media content. The data also comprises b) the second point in time the playback of the digital media content by the first user is configured to have ended. The second point in time is configured to have been freely chosen by the first user from the entire duration of the digital media content. The second node is also further configured to initiate providing the second indication of the data configured to be collected to at least one of: the first node configured to be comprised in the computer system, and the another node configured to be comprised in the computer system.

According to a sixth aspect of embodiments herein, the object is achieved by the third node, configured to handle the digital media content. The digital media content comprises at least one of: digital audio and digital video. The third node is configured to be comprised in a computer system. The third node is further configured to receive, from the first node configured to be comprised in the computer system, the first indication of the segment of the digital media content configured to be determined to be of interest to the first user of the second node. The second node is configured to provide the digital media content to the first user and to be comprised in the computer system. The segment of the digital media content is configured to have been determined to be of interest based on the analysis of data configured to be collected on seeking of the digital media content by at least one second user. The points in time are configured to have been chosen by the least one second user, from the entire duration of the digital media content. The third node is further configured to initiate providing, on the interface of the third node, the third indication of the segment of the digital media content determined to be of interest to the first user, based on the first indication configured to be received.

According to a seventh aspect of embodiments herein, the object is achieved by a computer program. The computer program comprises instructions which, when executed on at least one processor, cause the at least one processor to carry out the method performed by the first node.

According to an eighth aspect of embodiments herein, the object is achieved by computer-readable storage medium. The computer-readable storage medium has stored thereon a computer program comprising instructions which, when executed on at least one processor, cause the at least one processor to carry out the method performed by the first node.

According to a ninth aspect of embodiments herein, the object is achieved by a computer program. The computer program comprises instructions which, when executed on at least one processor, cause the at least one processor to carry out the method performed by the second node.

According to a tenth aspect of embodiments herein, the object is achieved by computer-readable storage medium. The computer-readable storage medium has stored thereon a computer program comprising instructions which, when executed on at least one processor, cause the at least one processor to carry out the method performed by the second node.

According to an eleventh aspect of embodiments herein, the object is achieved by a computer program. The computer program comprises instructions which, when executed on at least one processor, cause the at least one processor to carry out the method performed by the third node.

According to a twelfth aspect of embodiments herein, the object is achieved by computer-readable storage medium. The computer-readable storage medium has stored thereon a computer program comprising instructions which, when executed on at least one processor, cause the at least one processor to carry out the method performed by the third node.

By the first node automatically determining the segment of the digital media content to be of interest to the first user, based on the analysis of collected data on seeking of the digital media content in points in time freely chosen from the entire duration of the digital media content, a more accurate determination of which segment of the digital media content is of interest to the user may be achieved. This enables the first user to more efficiently navigate the digital media content, saving energy, e.g., battery, consumption and processing resources in the computer system. The third node is also enabled to receive the first indication of the determined segment and provide the third indication of the determined segment on its interface. This enables a user of the third node, e.g., a digital media content producer, to obtain more accurate data on which segments of the digital media content are of interest to the first user, facilitating the provision of these segment to consumers in the computer system, also enabling to save energy consumption and processing resources in the computer system. The second node enables and/or facilitates the determining of the segment by initiating providing the second indication of the collected data, which comprise the seeking information by the first user on the digital media content.

### BRIEF DESCRIPTION OF THE DRAWINGS

Examples of embodiments herein are described in more detail with reference to the accompanying drawings, and according to the following description.

FIG. 1 is a schematic diagram illustrating two non-limiting examples in a) and b), respectively, of a computer system, according to embodiments herein.

FIG. 2 is a flowchart depicting embodiments of a method in a first node, according to embodiments herein.

FIG. 3 is a flowchart depicting embodiments of a method in a second node, according to embodiments herein.

FIG. 4 is a flowchart depicting embodiments of a method in a third node, according to embodiments herein.

FIG. 5 is a schematic diagram illustrating an example of the different components of the computer system and their interactions, according to embodiments herein.

FIG. 6 is a schematic diagram illustrating an example of a method in a computer system, according to embodiments herein.

FIG. 7 is a schematic diagram illustrating another example of a method in a computer system, according to embodiments herein.

FIG. 8a is a schematic block diagram illustrating an example of a first node, according to embodiments herein.

FIG. 8b is a schematic block diagram illustrating another example of a first node, according to embodiments herein.

FIG. 9a is a schematic block diagram illustrating an example of a second node, according to embodiments herein.

FIG. 9b is a schematic block diagram illustrating another example of a second node, according to embodiments herein.

FIG. 10a is a schematic block diagram illustrating an example of a third node, according to embodiments herein.

FIG. 10b is a schematic block diagram illustrating another example of a third node, according to embodiments herein.

### DETAILED DESCRIPTION

As part of the development of embodiments herein, a problem will first be identified and discussed.

A significant portion of processing resources in the daily usage of computer systems, including telecommunication systems, are used for processing digital media content. Digital media content is typically characterized by large amounts of data. Therefore, facilitating navigation of the digital media content benefits both users and providers of the digital media content.

As explained earlier, the current methods of identifying interesting parts of digital media content are limited identifying pre-existing or fixed parts of the digital media content, which are of limited interest to users and/or providers.

In order to address this problem, several embodiments are comprised herein, which may be understood to relate to a system and method for identifying interesting parts of a digital media content, based on user behavior known as “seeking”. During seeking behavior, users tend to skip from one part of the media stream to another until they find the part they are interested in, and then reproduce this part until they stop the stream or skip to the next part. The seeking herein may be understood to be distinguished from a navigation based on chapters, or pre-defined or fixed parts, in that a user may freely chose the points in an entire duration of the digital media content that the user may skip to and start or end a playback.

Particular embodiments herein may be understood to relate to a classification of an interesting scene or scenes, based on the user behavior known as “seeking”. Further particularly, embodiments herein may be understood to relate to a system and method for identifying interesting scenes in media streams based on crowd sourced media seek behavior.

Embodiments will now be described more fully hereinafter with reference to the accompanying drawings, in which examples are shown. In this section, the embodiments herein will be illustrated in more detail by a number of exemplary embodiments. It should be noted that the exemplary embodiments herein are not mutually exclusive. Components from one embodiment may be tacitly assumed to be present in another embodiment and it will be obvious to a person skilled in the art how those components may be used in the other exemplary embodiments.

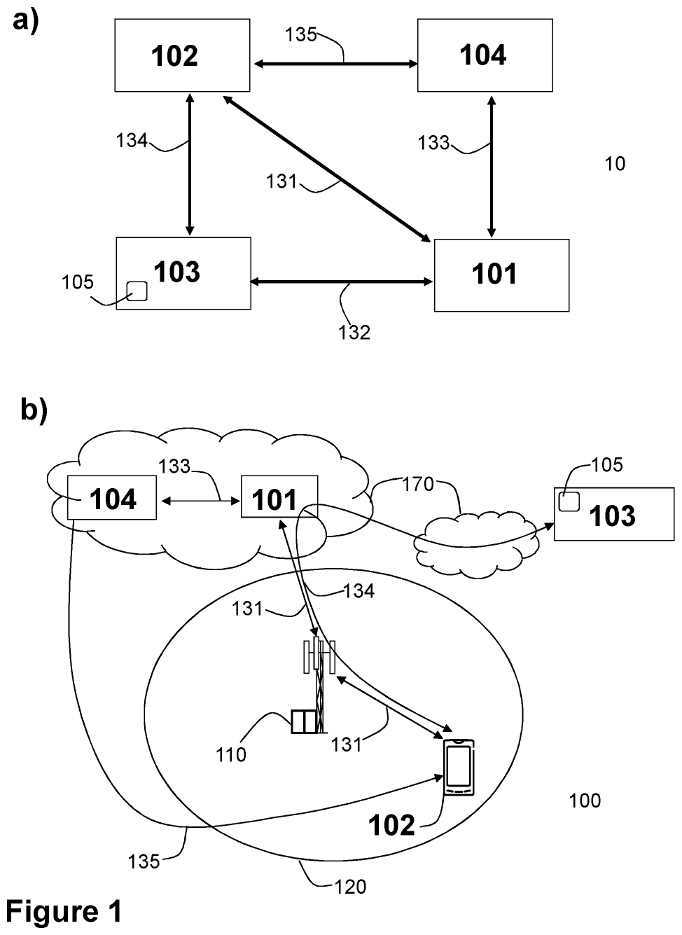

FIG. 1 depicts two non-limiting examples, in panels “a” and “b”, respectively, of a computer system 10, in which embodiments herein may be implemented. In some example implementations, such as that depicted in the non-limiting example of FIG. 1a, the computer system 10 may be a computer network. In other example implementations, such as that depicted in the non-limiting example of FIG. 1b, the computer system 10 may be implemented in a telecommunications network 100, sometimes also referred to as a cellular radio system, cellular network or wireless communications system. The telecommunications network 100 may for example be a network such as 5G system, Next Gen network, a Long-Term Evolution (LTE) network, e.g. LTE Frequency Division Duplex (FDD), LTE Time Division Duplex (TDD), LTE Half-Duplex Frequency Division Duplex (HD-FDD), LTE operating in an unlicensed band, Wideband Code Division Multiple Access (WCDMA), Universal Terrestrial Radio Access (UTRA) TDD, Global System for Mobile communications (GSM) network, GSM/Enhanced Data Rate for GSM Evolution (EDGE) Radio Access Network (GERAN) network, Ultra-Mobile Broadband (UMB), EDGE network, network comprising of any combination of Radio Access Technologies (RATs) such as e.g. Multi-Standard Radio (MSR) base stations, multi-RAT base stations etc., any 3rd Generation Partnership Project (3GPP) cellular network, Wireless Local Area Network/s (WLAN) or WiFi network/s, Worldwide Interoperability for Microwave Access (WiMax), IEEE 802.15.4-based low-power short-range networks such as 6LowPAN, Bluetooth, or any cellular network or system. In some examples, the telecommunications network 100 may be a non-cellular system, comprising network nodes which may serve receiving nodes, such as wireless devices, with serving beams. This may be a typical case, e.g., a in a 5G network using New Radio (NR).

The computer system 10 comprises a plurality of nodes, whereof a first node 101, a second node 102, a third node 103, and a fourth node 104 are depicted in FIG. 1. Any one or more of the third node and the fourth node may be referred to herein as, which may also be referred to herein as another node.

Each of the first node 101, the second node 102, the third node 103 and the fourth node 104 may be understood, respectively, as a first computer system, a second computer system, a third computer system, and a fourth computer system. In some examples, each of the first node 101, the second node 102, the third node 103 and the fourth node 104 may be implemented, as depicted in the non-limiting example of FIG. 1b for the first node 101, the third node 103 and the fourth node 104, as a standalone server in e.g., a host computer in the cloud 170. Each of the first node 101, the third node 103, and the fourth node 104 may in some examples be a distributed node or distributed server, with some of their respective functions being implemented locally, e.g., by a client manager, and some of its functions implemented in the cloud 170, by e.g., a server manager. Yet in other examples, each of the first node 101, the third node 103, and the fourth node 104 may also be implemented as processing resources in a server farm. Each of the first node 101, the third node 103, and the fourth node 104 may be under the ownership or control of a service provider, or may be operated by the service provider or on behalf of the service provider.

As depicted in the FIG. 1b, the second node 102 may be understood as e.g., a client computer, in the telecommunications network 100. The second node 102 may be for example, as depicted in the example of FIG. 1b, a wireless device as described below, e.g., a User Equipment (UE).

The third node 103 has an interface 105, which may be an audio/visual interface such as a television, projector or computer monitor combined with speakers, but may also be an electronic interface such as a database, which stores interesting scenes for a particular user, etc. . . .

In some embodiments, any or all of the first node 101, the second node 102, the third node 103 and the fourth node 104 may be co-located or be the same device. All the possible combinations are not depicted in FIG. 1 to simplify the Figure.

When comprised in the telecommunications network 100, any of the first node 101, the third node 103, and the fourth node 104, may be a network node such as a Remote Radio Unit (RRU), a Remote Radio Head (RRH), a multi-standard BS (MSR BS), a core network node, e.g., a Mobility Management Entity (MME), Self-Organizing Network (SON) node, a coordinating node, Minimization of Driving Test (MDT) node, etc. . . . In some particular examples, the fourth node 104 may be Home Subscriber Server (HSS) or a Home Location Register (HLR) of a core network. In some examples, the third node 103 may be an Application Programming Interface (API) for service access in the core network. Any of the first node 101, the third node 103, and the fourth node 104, may, in other examples, be also be a, same or different, wireless device.

The telecommunications network 100 covers a geographical area which, which in some embodiments may be divided into cell areas, wherein each cell area may be served by a radio network node 110, although, one radio network node may serve one or several cells. In the example of FIG. 1b, the radio network node 110 serves a cell 120. The radio network node 110 may be a radio network node, such as e.g., a gNB. That is, a transmission point such as a radio base station, for example an eNB, an eNodeB, or a Home Node B, a Home eNode B or any other network node capable to serve a wireless device, such as a user equipment or a machine type node in the telecommunications network 100. The radio network node 110 may be of different classes, such as, e.g., macro eNodeB, home eNodeB or pico base station, based on transmission power and thereby also cell size. In some examples wherein the telecommunications network 100 may be a non-cellular system, the radio network node 110 may serve receiving nodes with serving beams. The radio network node 110 may support one or several communication technologies, and its name may depend on the technology and terminology used. In 3GPP LTE, any of the radio network nodes that may be comprised in the telecommunications network 100 may be directly connected to one or more core networks.

A plurality of wireless devices may be located in the wireless communication network 100. Any of the wireless devices comprised in the telecommunications network 100 may be a wireless node such as a 5G UE, or a UE which may also be known as e.g., mobile terminal, wireless terminal and/or mobile station, a mobile telephone, cellular telephone, or laptop with wireless capability, just to mention some further examples. Any of the wireless devices comprised in the telecommunications network 100 may be, for example, portable, pocket-storable, hand-held, computer-comprised, or a vehicle-mounted mobile device, enabled to communicate voice and/or data, via the RAN, with another entity, such as a server, a laptop, a Personal Digital Assistant (PDA), or a tablet computer, sometimes referred to as a surf plate with wireless capability, Machine-to-Machine (M2M) device, device equipped with a wireless interface, such as a printer or a file storage device, modem, or any other radio network unit capable of communicating over a wired or radio link in a communications system. Any of the wireless devices comprised in the telecommunications network 100 is enabled to communicate wirelessly in the telecommunications network 100. The communication may be performed e.g., via a RAN and possibly one or more core networks, comprised within the telecommunications network 100.

The first node 101 is configured to communicate within the computer system 10 with the second node 102 over a first link 131, e.g., a radio link or a wired link. The first node 101 is configured to communicate within the computer system 10 with the third node 103 over a second link 132, e.g., another radio link or another wired link. The first node 101 is configured to communicate within the computer system 10 with the fourth node 104 over a third link 133, e.g., another radio link or another wired link. The second node 102 may be further configured to communicate within the computer system 10 with the third node 103 over a fourth link 134, e.g., another radio link, a wired link, an infrared link, etc. . . . . The second node 102 may be further configured to communicate within the computer system 10 with the fourth node 104 over a fifth link 135, e.g., another radio link, a wired link, an infrared link, etc. . . .

Any of the first link 131, the second link 132, the third link 133, the fourth link 134, and the fifth link 135 may be a direct link or it may go via one or more computer systems or one or more core networks in the telecommunications network 100, which are not depicted in FIG. 1, or it may go via an optional intermediate network. The intermediate network may be one of, or a combination of more than one of, a public, private or hosted network; the intermediate network, if any, may be a backbone network or the Internet; in particular, the intermediate network may comprise two or more sub-networks, which is not shown in FIG. 1.

In general, the usage of “first”, “second”, “third”, and/or “fourth” herein may be understood to be an arbitrary way to denote different elements or entities, and may be understood to not confer a cumulative or chronological character to the nouns they modify.

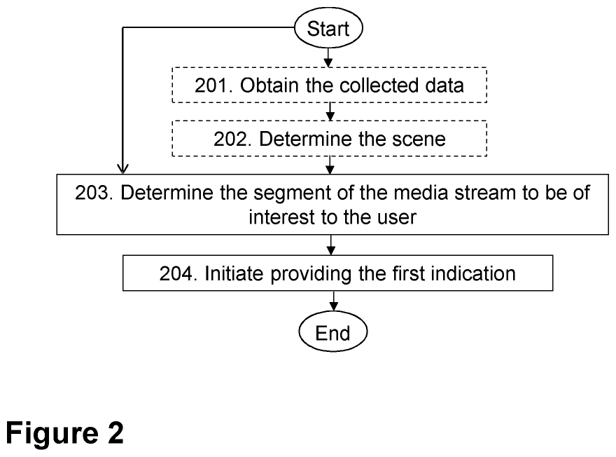

Embodiments of a method, performed by a first node 101, for handling a digital media content, will now be described with reference to the flowchart depicted in FIG. 2. The digital media content comprises at least one of: digital audio and digital video. As stated earlier, the node 101 is comprised in the computer system 10.

The method may comprise one or more of the following actions. In some embodiments all the actions may be performed. In some embodiments, one or more actions may be performed. One or more embodiments may be combined, where applicable. All possible combinations are not described to simplify the description. In FIG. 2, optional actions are indicated with dashed lines.

Action 201

The method performed by the first node 101 may be understood to be aimed at identifying a parts or parts of a digital media content, e.g., a song or a movie streamed from the internet, which may be of interest to a user. The user is a first user of the second node 102 comprised in the computer system 10, which is providing the digital media content to the first user. That is, the second node 102, e.g., a smartphone, is reproducing, displaying, playing etc. . . . digital media content for the user.

To ultimately enable the identification of the part or parts of the digital media content which are of interest to the first user, in this Action, the first node 101 obtains collected data from at least one of: the first node 101, the second node 102, and the another node 103, 104 comprised in the computer system 10. Collected data may be understood herein as data that has been collected, that is stored, saved or registered.

Obtaining in this Action 201 may comprise any of collecting, storing, saving, registering, retrieving, requesting, or receiving, e.g., from the second node 102 via the first link 131, or from the fourth node 104 via the third link 133.

The collected data may be about a seeking behavior of the first user himself/herself, from another user or users, or from both. In other words, the collected data may be understood herein to be about the seeking behavior of at least one second user. The at least one second user may be understood to comprise at least one of: a) the first user, and b) another one or more users having played back the digital media content.

The seeking behavior may be understood to be in regards to a playback of a part of the digital media content. That is, the seeking behavior may be understood as the actions taken by the at least one second user of the digital media content to search a part or segment of the digital media content that is of interest to the at least one second user. This may fast forwarding a movie to a particular point, and then playing back the movie until a second point.

According to the foregoing, in some embodiments, the collected data may be about a seeking behavior of the first user. In some of these embodiments, the collected data may comprise on at least one of the following options a) and b). In some embodiments, the collected data may comprise a) a first point in time, e.g., T₀, a playback of the digital media content by the first user started, at an earlier occasion. The first point in time may be understood to have been freely chosen by the first user, from the entire duration of the digital media content. In other words, the first point in time may be understood to not necessarily be a pre-configured or fixed search point in the digital media content, such as a chapter in a movie, or a track number in a digital music album, but is capable of being any of the time points comprising the whole length of digital media content. For example, if the digital media content is a movie, from the beginning of the movie, to the end of the movie. In these embodiments, the collected data may also comprise a second point in time, e.g., T₁, the playback of the digital media content by the first user ended at the earlier occasion. The second point in time may be understood to equally have been freely chosen by the user.

Any of the first point in time and the second point time may have been collected as, e.g., a time stamp. The part of the digital media content comprised between the first point in time and the second point in time may be understood as the playback.

In some embodiments, the collected data may comprise b) a number of times, e.g., Xₙ, the playback was played by the first user. Since from one playback time, X₁, to another, X₂, the first user may vary slightly the start point of the playback and the ending point of the playback, every playback may have been counted, based on a first margin of the first point in time and a second margin of the second point in time from the entire duration of the digital media content. The first margin and the second margin may be understood as e.g., a first variance and a second variance, due to the fact that the first user may choose the points in time freely, and may not choose exactly the same point in time from one occasion to another.

According to the foregoing, in some embodiments, the collected data may be about a seeking behavior of the another one or more users. For these embodiments, the collected data may be similarly collected as just described for the first user, for each one of the another one or more users. In some of these embodiments, the collected data may comprise at least one of the following options a) and b), for a respective playback for each of the another one or more users. In some embodiments, the collected data may comprise a) a respective first point in time, e.g., T₀ᵢ, the respective playback of the digital media content by a respective first user of the another one or more users started, at a respective earlier occasion. The respective first point in time may be understood to have been freely chosen by the respective first user of the another one or more users from the entire duration of the digital media content. In these embodiments, the collected data may also comprise a respective second point in time, e.g., T₁ᵢ, the respective playback of the digital media content by the respective first user of the another one or more users ended at the respective earlier occasion. The respective second point in time may be understood to have been freely chosen by the respective first user of the another one or more users from the entire duration of the digital media content. In some embodiments, the collected data may comprise b) a respective number of times, e.g., Xᵢ, the respective playback was played by the respective first user of the another one or more users. Every playback may be understood to have been counted, based on the first margin of the first point in time and the second margin of the second point in time, as described earlier.

In the description just provided respective may be understood as pertaining to each of the another one or more users.

The collected data may also comprise other information. For example, the collected data may comprise demographic data, for e.g., the first user. Demographic data may be understood as e.g., age, gender, location, hobbies, educational level, occupation, nationality, languages spoken, etc. . . . . That is, any variable of a user that may influence what may be of interest to the user.

Other information comprised in the collected data may be an identifier for the user, and another identifier for the digital media content.

Action 202

One way to determine the segment of the digital media content to be of interest to the first user may be by having a knowledge of which parts of the digital media content have been found to be of interest to other users, such as the another one or more users, that is, which parts may have been found to be popular. This may increase a probability that the same part of the digital media content may also be of interest to the first user. This probability may be even higher if the first user shares one or more demographic characteristics such as age, gender, etc., with the another one or more users.

Once the first node 101 may have obtained the collected data, there may be, for each of the another one or more users a list of all the respective first points in time and the respective second points in time, that is, a list of <first point in time, second point in time> tuples for every playback, which may be understood herein as a timeline. Once interesting timeline lists from all users may have been obtained, then the first node 101 may determine “scenes”. A scene may be understood as a particular part of the digital media content that may be found to be popular by the at least one second user, typically, by the another one or more users.

The scene may be determined taking into consideration that the respective first point in time and the respective second point in time for each of the another one or more users may vary slightly, that is, within the first margin and second margin, respectively, for every user. Therefore, the scene may be understood as an averaged part of the digital media content, namely, a part with an averaged beginning and an averaged ending, that has been found to be played by the another one or more users over a particular length of time—referred to herein as a first threshold-, more than a certain number of times, e.g., at least twice.

According to the foregoing, in this Action 202, the first node 101 may determine a scene in the digital media content, based on whether the respective duration of time between the respective first time point and the respective second time point is above the first threshold, respectively, for the another one or more users for at least two playbacks.

In other words, if there is more than one playback where the respective duration is above the first threshold, this may be considered a scene, taking into consideration that the respective first point in time and the respective second point in time are within the first margin and second margin, respectively.

Expressed differently, based on an array of one or more segments of the digital media content found to be of interest for every user, the first node 101 may calculate at least one segment of common interest for the another one or more users, which is referred to herein as a scene. It may be understood that more than one scene may be determined in the digital media content.

In some examples, the first node 101 may also determine the scene in the digital media content, based on whether the respective number of times the respective playback was played is above a specific number of times, referred to herein as a second threshold, respectively, for the another one or more users.

The first node 101 may also determine the scene in the digital media content, based on whether the duration of time between the first time point and the second time point is above the first threshold, for the first user, for at least two playbacks. Alternatively, or additionally, the first node 101 may also determine the scene in the digital media content, based on whether the number of times the playback was played is above the second threshold for the first user. However, in typical examples, this may be performed based on the another one or more users.

Determining, as used herein, may be understood as deriving, calculating, itself or as receiving from another node comprised in the computer system 10.

In some examples, the determining in this Action 202, of the scene in the digital media content, may be based on whether an aggregated number of times, for all the another one or more users, the respective number of times the respective playback was played, is above a third threshold, that is a certain number of times.

Further details on how the scene may be determined are provided below under the section “Interesting Scene Computation on Request”.

Action 203

In this Action 203, the first node 101 determines, automatically, a segment of the digital media content to be of interest to the first user of the second node 102 providing the digital media content to the first user. As stated earlier, the second node 102 is comprised in the computer system 10. The determining in this Action 203 is based on an analysis of the collected data on seeking of the digital media content by the at least one second user. As explained above, the seeking has been performed in points in time in the digital media content, which the points in time have been freely chosen by the least one second user from the entire duration of the digital media content.

In some embodiments, the segment of the digital media content may be determined to be of interest to the first user based on the collected data on the first user himself/herself. That is, in some embodiments, the segment of the digital media content may be determined to be of interest to the first user based on whether at least one of: i) a duration of time between the first time point and the second time point is above the first threshold, and ii) the number of times the playback was played by the first user is above the second threshold. The first threshold may be understood as a number of time units, e.g., seconds, minutes, hours, etc. . . . The second threshold may be understood as another number, e.g., twice, three times, four times, etc. . . .

In some embodiments, the segment of the digital media content may be determined to be of interest to the first user based on the collected data on the another one or more users. Namely, if a particular part is of interest to others, then it may also be of interest to the first user. Accordingly, in some embodiments, the segment of the digital media content may be determined to be of interest to the first user based on whether at least one of: i) a respective duration of time between the respective first time point and the respective second time point is above a first threshold, respectively, for the another one or more users, and ii) the respective number of times the respective playback was played is above a second threshold, respectively, for the another one or more users.

In some embodiments wherein the scene may have been determined, as e.g., described in relation to Action 202, the determining the segment of the digital media content to be of interest to the first user in this Action 203 may be further based on a comparison of the segment of the digital media content with the scene. If for example, the first point in time is within a certain margin from the beginning of the scene, or the second point in time is within a certain a certain margin from the ending of the scene, or both, the segment determined to be of interest for the first user may correspond to the scene. Alternatively, or additionally, the determining 203 the segment of the digital media content to be of interest to the first user may be further based on demographic data of the first user. The segment of the digital media content may be determined to be of interest to the first user based on whether or not the demographic data of the first user match a set of demographic data mapped to the segment. Mapped understood here as being associated with, or tagged. The set of demographic data mapped to the segment may be based on the collected data on seeking of the digital media content by the another one or more users. Therefore for example, if the first user is a male in his twenties that likes soccer, the determined segment to be of interest to him may be a scene that has been found to be popular among other makes in their twenties that like soccer.

In some examples, the determining in this Action 203 may be performed by the first node 101 based on a request received from at least one of: the second node 102 and the third node 103. In particular examples, the request itself may already comprise one or more indicators of the demographic data of the first user, which may be used as a filter by the first node 101 to determine the segment of the digital media content be of interest to the first user.

According to the foregoing, the first node 101 may also be referred to herein as a “Seek Behavior Analysis (SBA) component”, as it may be understood to analyze the seek behavior of the at least one second user. Particular examples of embodiments herein may relate to computation of interesting scenes in one or multiple media streams on request, based on viewer seeking behavior.

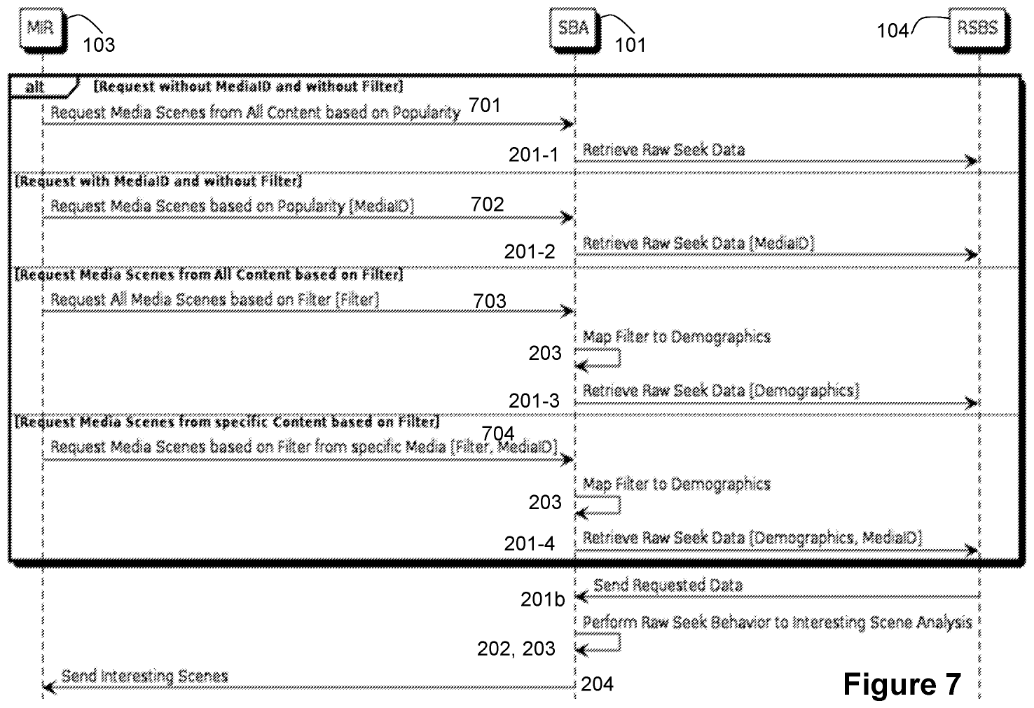

Some specific examples of the analysis that may be performed by the first node 101 in this Action 203 are provided below in relation to FIG. 7.

Action 204

In this Action 204, the first node 101 initiates providing a first indication of the determined segment of the digital media content to be of interest to the first user, to at least one of the second node 102, and another node 103, 104 comprised in the computer system 10.

Initiating providing may be understood as beginning or triggering outputting, or sending.

The providing in this Action 204 may be performed, e.g., to the second node 102 via the first link 131, to the third node 103, or to the fourth node 104, e.g., via the third link 133.

The first indication may comprise information about the boundary of the segment, e.g., the time codes of the beginning and the end, the actual segment, such as chorus of a song, a clip of a movie, a specific part of a broadcast such as news section, a football match, a documentary, a part of an e-radio broadcast such as speech section etc. The first node 101 may also initiate providing the first indication to a memory device, e.g., a metadata database node, for storage.

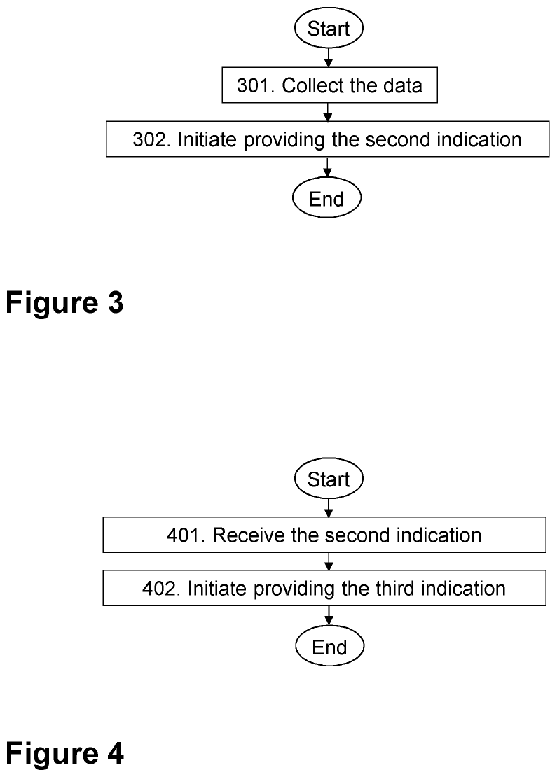

Embodiments of a method, performed by the second node 102, for handling the digital media content, will now be described with reference to the flowchart depicted in FIG. 3. As stated earlier, the second node 102 is comprised in the computer system 10.

The detailed description of some of the following corresponds to the same references provided above, in relation to the actions described for the first node 101, and will thus not be repeated here. For example, the digital media content comprises at least one of: digital audio and digital video. One or more embodiments may be combined with any of the features described in relation to the first node 101, where applicable. All possible combinations are not described to simplify the description.

The method comprises the following actions.

Action 301

The second node 102, e.g., the first user's smartphone, may be understood to be a node which may provide the digital media content to the first user. Examples of the second node 102 may be a mobile phone, television, laptop, vehicle infotainment system, etc. The second node 102 may reproduce video content coming from a content producer, and have the capability to capture and transmit user seeking behavior for storage. As such, the second node 102 may have connectivity means to both content producers such as the fourth node via, e.g., the fifth link 135, and a seek behavior storage database, see below.

Accordingly, in this Action 301, the second node 102 collects data from the first user of the second node 102 on seeking the digital media content. The data comprises: a) the first point in time the playback of the digital media content by the first user started, wherein the first point in time was freely chosen by the first user from the entire duration of the digital media content; and b) the second point in time the playback of the digital media content by the first user ended, wherein the second point in time was freely chosen by the first user from the entire duration of the digital media content.

In some embodiments, the collected data may further comprise: the number of times the playback was played by the first user, wherein every playback was counted, based on the first margin of the first point in time and the second margin of the second point in time.

In some embodiments, the collecting in this Action 301 of the data may be performed for the at least one second user comprising the another one or more users having played back the digital media content. Is such embodiments, the collected data may comprise at least one of following options a) and b), for the respective playback for each of the another one or more users. In option a) the collected data may comprise the respective first point in time the respective playback of the digital media content by the respective first user of the another one or more users started, at the respective occasion. The respective first point in time may be understood to have been freely chosen by the respective first user of the another one or more users from the entire duration of the digital media content. In option a) the collected data may also comprise the respective second point in time the respective playback of the digital media content by the respective first user of the another one or more users ended at the respective earlier occasion. The respective second point in time may be understood to have been freely chosen by the respective first user of the another one or more users from the entire duration of the digital media content. In option b), the collected data may comprise the respective number of times the respective playback was played by the respective first user of the another one or more users. Every playback may be understood to have been counted, based on the first margin of the first point in time and the second margin of the second point in time.

In addition, to capture the seek behavior of the first user, in this Action 301, the second node 102 may be able to collect other information. For example, the second node 102 may be able to capture and collect the demographic data, for e.g., the first user. This information may be available online, e.g., in widely used social media websites. In some examples, user demographic information may be appended to the seek behavior information. Other information the second node 102 may collect may be the identifier for the user, and another identifier for the digital media content.

Action 302

In this Action 302, the second node 102 initiates providing, a second indication of the collected data to at least one of: the first node 101 comprised in the computer system 10, via e.g., the first link 131, and another node 103, 104 comprised in the computer system 10, via e.g., the second link 132, or the third link 133. The second node 102 may also initiate providing the third indication to a database for storage. The content of the second indication may depend on the collected data. Examples of the second indication may be, for the identifier for the user: ““userID”:“user1””, for the another identifier for the digital media content: ““mediaID”:“media1””, for the demographic data “age”:“34”, “location”:“Athens,Greece”, “hobbies”:“Astronomy,Photography”, “occupation”:“Computer Programmer””, for the first point in time ““seek_start”:“04:44””, for the second point in time ““seek_to”:“01:02:43””, etc. . . . Another example of the second indication may be a message, referred to herein as e.g., a “seek and playback message”. This is further described later under the section “Seek and Store Data”.

Embodiments of a method, performed by a third node 103, for handling the digital media content will now be described with reference to the flowchart depicted in FIG. 4. As stated earlier, the third node 103 is comprised in the computer system 10.

The detailed description of some of the following corresponds to the same references provided above, in relation to the actions described for the first node 101, and will thus not be repeated here. For example, the digital media content comprises at least one of: digital audio and digital video. One or more embodiments may be combined with any of the features described in relation to the first node 101, where applicable. All possible combinations are not described to simplify the description.

The method comprises the following actions.

Action 401

The third node 103 may be understood as a node which may be operated by a party with an interest in knowing which segment of the digital media content may be of interest to the first user. This party may be for example a digital media content producer.

In this Action 401, the third node 10 receives, from the first node 101 comprised in the computer system 10, the first indication of the segment of the digital media content determined to be of interest to the first user of the second node 102. As stated earlier, the second node 102 provides the digital media content to the first user, and the second node 102 is comprised in the computer system 10. The segment of the digital media content has been determined to be of interest based on the analysis of the collected data on the seeking of the digital media content by the at least one second user. Also as explained above, the points in time have been freely chosen by the least one second user, from the entire duration of the digital media content.

The receiving in this Action 301 may be implemented, e.g., via the second link 132. The analysis has been described in relation to Action 203.

As explained above, the at least one second user may comprise at least one of: the first user, and the another one or more users having played back the digital media content.

Action 402

In this Action 402, the third node 103 initiates providing, on the interface 105 of the third node 103, a third indication of the segment of the digital media content determined to be of interest to the first user, based on the received first indication.

The third indication may be a similar indication to that of the first indication, in that it may comprise information about the boundary of the segment, e.g., the time codes of the beginning and the end, the actual segment, such as chorus of a song, a clip of a movie, a specific part of a broadcast such as news section, a football match, a documentary, a part of e-radio broadcast such as speech section etc. The third node 103 may also initiate providing the third indication to a database for storage.

According to the foregoing, one advantage of embodiments herein is that the methods described capture and analyze seeking behavior of users in of digital media content, and may classify it as interesting. This then enables to build a database of interesting parts of digital media contents. The information that may be contained in this database may be of great value to many stakeholders, for example to content providers of, as feedback to which part of their movie or audio piece is interesting.

Embodiments herein may be understood to have broad applicability. for example to producers of digital audio, digital video or both, as a more fine-grained indication of user interest that may be used as primer for creating new content, to content distributors, e.g., for producing content previews/trailers such as automatic composition of movie/song previews based on popular segments, but also to content consumers for abbreviated playback of the said content, e.g., by enabling skipping to an interesting part of the content a priori, sans manual seeking. Moreover, this information may be used for the implementation of advanced caching techniques and to influence different ways of encoding media, such as pre-caching of interesting segments or use of a higher quality when encoding/decoding interesting parts, as opposed to non-interesting parts of media.

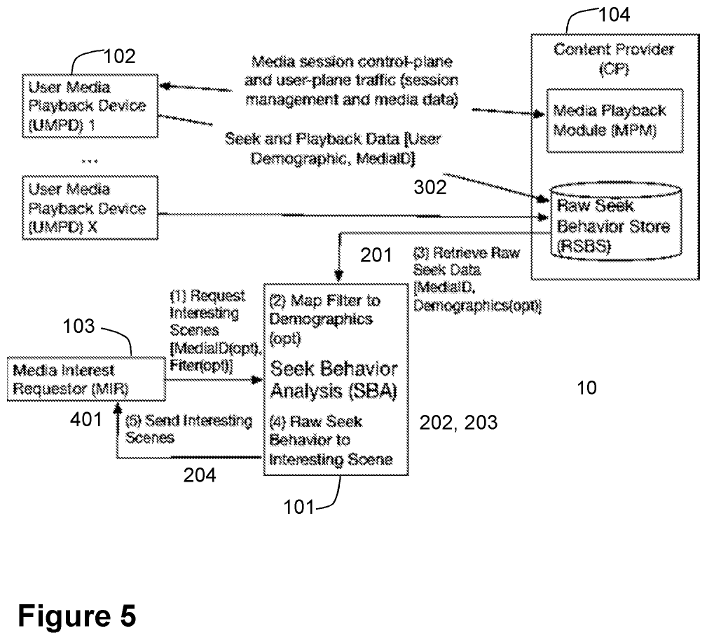

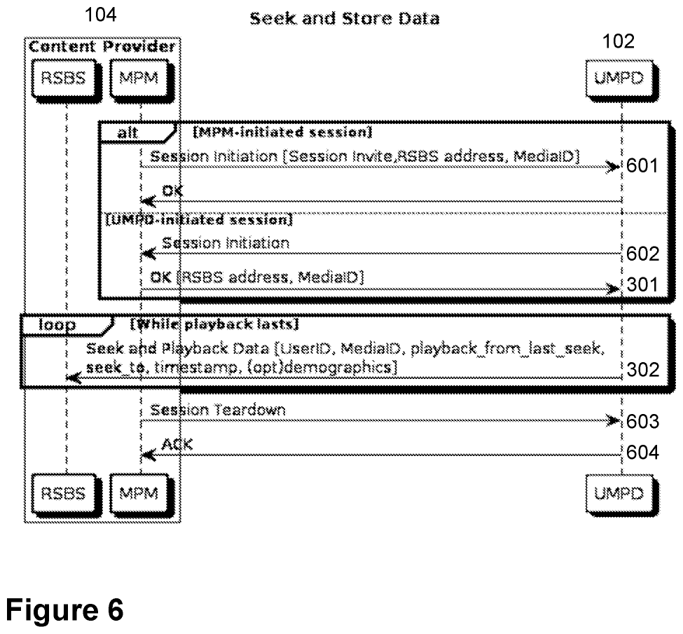

To further illustrate the embodiments herein, some particular non-limiting examples of embodiments herein will now be provided in further detail with regards to FIG. 5, FIG. 6 and FIG. 7.

FIG. 5 is a schematic block diagram of a particular non-limiting example of the computer system 10, with an overview of the actions performed, according to embodiments herein. Interactions are prefixed by a sequence number. Seek interactions may be stored all the time, hence the absence of a sequence number. In FIG. 5, the computer system 10 comprises the following entities.

The computer system 10 comprises the second node 102, which in FIG. 5 is a User Media Playback Device (UMPD). The computer system 10 may in fact comprise one or more (X) User Media Playback Devices (UMPDs), such as the second node 102.

The computer system 10 comprises the fourth node 104, which in FIG. 5 is a Content Provider (CP) entity. The fourth node 104 in this example comprises a Media Provisioning Module (MPM) and a Raw Seek Behavior Store database (RSBS). The Media Provisioning Module (MPM) may provide the digital media content, e.g., user-plane media stream data, to the requesting UMPDs and does control-plane basic media session management, e.g., session initiation and teardown. The Raw Seek Behavior Store database (RSBS), may store raw seek behavior from the at least one second user. The records in the database may also comprise information about the demographics of the at least one second user. The database may also have an interface to provide data to requesting entities.

The computer system 10 comprises the third node 103, which in FIG. 5 is a Media Interest Requestor (MIR) component, which requests the segment of interest to the first user, or interesting scenes from the first node 101 at (1). The request may contain an optional Media identifier, identifying a specific digital media content, and optionally, the request may also contain an interest filter to be used. The interest filter may be a description of the type of interest the media interest requestor has on the segment or the scenes.

The computer system 10 comprises the first node 101, which in FIG. 5 is named as a Seek Behavior Analysis (SBA) component. The first node 101, upon request, may at (4) analyze raw seek behavior data from the RSBS for determining the segment of interest or the interesting scenes, according to Actions 203 and 202. In the examples wherein the demographic data may be used to determine the segment to be of interest to the first user, the first node 101 at (2) may perform the additional task of mapping and grouping the interest filter that may be comprised on the request to the demographic data, so that only the data submitted from users of similar demographics to the RSBS may be analyzed. To perform Actions 202 and 203, at (3), the first node 101 may obtain the collected data from the fourth node 104 according to 201. If no digital media content identifier is supplied in the request, then the analysis at (4) may be done for all digital media content identifier in the RSBS, and/or if no interest filter is supplied, then the analysis at (4) may be done for RSBS-stored media disregarding any demographics metadata. The first node 101 may at (5) subsequently transmit the first indication as a response to the original request.

Seek and Store Data

This subsection describes how the data may be collected by the second node 102 in Action 301, and/or how the collected data may be obtained by the first node 101 in Action 201 with particular, non-limiting, examples. That is, the packet format of the store request of seek behavior, as well as the structure the RSBS, for example, may use to store this behavior. The “seek and store” process may be understood to happen continuously. There may be many UMPDs transmitting to the same RSBS.

The collected data may be a packet payload, which may be encapsulated in a TCP/IP or UDP/IP protocol stack, for example, and sent in a message as the second indication. The packet payload corresponding to the collected data for the first user, identified as “user1” in a store request from the RSBS, may for example, have the following structure, which here includes the optional demographic data for the first user and is expressed in a non-limiting, exemplary Javascript Object Notation (JSON) format:

{

“userID”:”user1”,
“mediaID”:”media1”,
“seek_start”:”04:44”,
“seek_to”:”01:02:43”,
“timestamp”:”2017-01-01 12:32”,
“demographics”:[

“age”:”34”,
“location”:”Athens,Greece”,
“hobbies”:”Astronomy,Photography”,
“occupation”:”Computer Programmer”

]

}

The collected data includes, in this non-limiting example, a user identifier which is unique. The identifier may be an alphanumeric, such as for example the Media Access Control (MAC) address of the radio interface belonging to the second node 102, e.g., an UMPD, transmitting this information. Additionally, a media identifier describing the digital media content, e.g., a media stream, that the first user of UMPD is seeking on. The identity of the digital media content may be well known to the UMPD, as it may have been established during session negotiation with the content provider. For example, when streaming media using the Session Initiation Protocol (SIP) protocol and in the Session Description Protocol which may be used as payload to SIP messages that establish the media session, the “s” attribute of the payload, denoting the “session name”, may be used to transfer a description of the digital media content. The digital media content identifier may also be unique. Therefore, it may also be an alphanumeric, such as for example the name of a movie appended with the movie duration.

The seek_start parameter corresponds to what has been described above as the first point in time, and the seek_to parameter corresponds to what has been described above as the second point in time. In this example, they are both timestamps. The seek_to parameter may be understood as the position the user sought to and describes a point in the timeline of the digital media content, since beginning of the digital media content. For example, in a movie timeline, since the beginning of the movie.

The database itself may be a relational or document database, which may either store the complete document, or create a table by splitting the parameters shown in the payload example above in cells, subsequently storing each request as a record of this table, for either the first user, or for each of the another one or more users.

FIG. 6 is a schematic diagram illustrating a non-limiting example of how the second node 102 and the fourth node 104 may interact during a media session lifetime, comprising session establishment and playback. The second node 102 is in this example a UMPD, and the fourth node 104 is a CP. As an example, FIG. 6 will be described using SIP protocol, but as one of skill in the art may understand, there may be other media session management protocols that may be used, for example H.323, and even HTTP/REST-based protocols.

In the example of FIG. 6, the media session starts with a session initiation message. In the case of SIP, the message is called SIP INVITE. There may be two options in this case. In a first option, the MPM part of the fourth node 104 may initiate the media session at 601. In this case, the SIP INVITE message may contain information about the RSBS IP address and the ID of the digital media content, which may be data collected by the second node 102 in Action 301. This information may be subsequently used in the second indication, e.g., the seek and playback data messages depicted in FIG. 5 at 302, from the UMPD. An example of such an INVITE message is shown below, with the parts in bold showing additions according to embodiments herein:

INVITE sip:cp@ 192.168.0.1 SIP/2.0

From: “MPM”<sip:mpm@ 192.168.0.1>;tag=dsads78dsa7d87sad6gfday

To: sip:umpd@ 192.168.10.1

Call-ID: f_ dsads78dsa7d87sad6gfday_l@ 192.168.0.1

CSeq: 15 INVITE

Via: SIP/2.0/UDP 10.101.6.120;branch=z9hG4bKf_66 dsadsa67ffgfdr_l

Content-Length: 348

Max-Forwards: 70

Contact: sip::cp@ 192.168.0.1;transport=udp

Content-Type: application/sdp

User-Agent: MediaStreamerExample

Supported: replaces

v=0

o=sip: mpm@ 192.168.0.1 16 IN IP4 192.168.0.1

s=sip: mpm@ 192.168.0.1

c=IN IP4 192.168.0.1

t=0 0

m=audio 5000 RTP/AVP 0 8 18 4 120

a=rtpmap:0 PCMU/8000/1

a=rtpmap:8 PCMA/8000/1

a=rtpmap:18 G729/8000/1

a=fmtp:18 annexb=no

a=rtpmap:4 G723/8000/1

a=rtpmap:120 telephone-event/8000/1

a=mediaID media1

a=RSBSIP 192.168.0.2

In a second option, the UMPD may initiate the media session at 602. In this case, the SIP INVITE message may contain a request for the MPM to share the mediaID and RSBS IP address, as shown below highlighted in bold, which may be this way collected as data by the second node 102 in Action 301:

INVITE sip: mpm@ 192.168.0.1SIP/2.0

From: “UMPD”<sip: umpd@ 192.168.10.1>;tag=dsads78dsa7d87sad6gfday

To: sip: mpm@ 192.168.0.1

Call-ID: f_ dsads78dsa7d87sad6gfday_l @ 192.168.0.1

CSeq: 15 INVITE

Via: SIP/2.0/UDP 192.168.10.1;branch=z9hG4bKf_66 dsadsa67ffgfdr_l

Content-Length: 348

Max-Forwards: 70

Contact: sip::sip: umpd@ 192.168.10.1;transport=udp

Content-Type: application/sdp

User-Agent: MediaStreamerExample

Supported: replaces

v=0

o=sip: umpd@ 192.168.10.1 16 IN IP4 192.168.0.1

s=umpd@ 192.168.10.1

c=IN IP4 192.168.0.1

t=0 0 m=audio 5000 RTP/AVP 0 8 18 4 120

a=rtpmap:0 PCMU/8000/1

a=rtpmap:8 PCMA/8000/1

a=rtpmap:18 G729/8000/1

a=fmtp:18 annexb=no

a=rtpmap:4 G723/8000/1

a=rtpmap:120 telephone-event/8000/1

a=request MediaID RSBSIP

The response from CP's MPM module may then include the Media ID and RSBS IP as:
{“mediaID”: “Medial”, “RSBSIP”:192.168.0.2}

Subsequently to session establishment in any of the two ways above, the collected data, e.g., the seek data, may be sent, according to Action 302, in the second indication by the second node 102 to the fourth node 104. In FIG. 6, the “seek_start parameter” is depicted as “playback_from_last_seek”. The second indication may be, for example, a SIP INFO Message from the UMPD to the RSBS. The payload of the SIP info message may be in Javascript Objet Notation (JSON) format, as per the example in the third paragraph under the heading “Seek and Store data”. The data may be sent every time a new seek may happen on the UMPD.

The session may then be torn down at 603 by the fourth node 104, and this may be acknowledged by the second node 102 at 604.

Interesting Scene Computation on Request

FIG. 7 is a schematic diagram illustrating different non-limiting examples of embodiments herein related to the analysis that may be performed by the first node 101 for the determination of the segment of digital media content to be of interest to a first user, triggered on a request from the third node 103. Here, the third node 103 is the MIR, the first node 101 is the SBA and the fourth node 104 is represented as the RSBS. In a first example, if no interest filter is specified in the request from the third node 103 at 701, then the first node 101 may assume that the segment to be of interest to the first user corresponds to a scene which is the one that is most popular among the another one or more users, that is, the one with most occurrences in the RSBS. The first node 101, according to Action 201, may retrieve the collected data, represented as “raw seek data”, about the at least one second user, from the fourth node 104, at 201-1. In a second example, if a media identifier is specified in the request at 702, then the first node 101 may retrieve, according to Action 201, the collected data as all records with the same media ID about the at least one second user from the RSBS at 201-2.

In a third example, for the requests wherein a custom filter may be specified at 703, a mapping function performed by the first node 101 may map the demographic data of the first user in the filter specified to demographic data by the another one or more users, according to some embodiments of Action 203, and then determine the segment mapped to the demographic data by the another one or more users. Table 1 illustrates an example of how this mapping may be implemented from a filter to viewer group demographics. The * wildcard designates “any number of characters”).

TABLE 1

| Filter | Demographics that match to filter |
|---|---|
| Young Technology-Minded | Age between 15 and 35, Occupation: |
| People | “Student” OR “*Engineer” OR “*IT*” |
| Old Spanish Speaking People | Age over 65 and location Spain, Latin |
| | America |
| Middle-Age Managers | Age between 38 and 55, Occupation |
| | “*Manager*” |

Once the raw seek data is retrieved from the RSBS by the first node 101 at 201-3, in accordance with Action 201, as FIG. 7 shows, the first node 101 may classify the collected data obtained, that is, the raw seek data, in scenes. That is, the first node 101 may determine one or more scenes in the digital media content, according to Action 202.

The first node 101 may work on a specific digital media content and may be triggered on request from MIR at 704. For every user of the at least one second user, the first node 101 may retrieve the seek records from the RSBS from this user, e.g., at 201-4, in accordance with Action 201. If a mediaID is provided, such as in the second and fourth examples as illustrated in FIG. 7 at 702 and 704, respectively, then the first node 101 may choose all the seek records for the specific media ID, that is, for the specific digital media content, e.g., a media stream, per user. Otherwise, the first node 101 may retrieve all seek records per user regardless of the digital media content.

An exemplary algorithm of how this may be performed is shown below. Any reference to the at least one second user, may be understood to apply in particular examples, to the another one or more users. The at least one second user may also be referred to as a/the user.

First, the input and output may be defined as follows:

### Let

S={s₁, s₂, . . . sₙ} be the n number of seek records returned from the RSBS for the at least one second user, where sₓ={mediaID, useridₓ, seek_startₓ, seek_toₓ, demographicsₓ} and demographicsₓ={d.ageₓ, d.locationₓ, d.hobbiesₓ, d.occupationₓ}, xϵ[1, . . . , n]
u be the number of users, that is the at least one second user.
threshold be a number in units of time that is configurable a priori, e.g., from the content provider, and indicates the playback time limit from which and above, the part of the media content the user played at the earlier occasion is considered interesting. The value of this limit may vary depending on the type of medium, its length and purpose. This is an example of the first threshold, or the respective first threshold.
scene_margin be a number in units of time that indicates the upper limit of deviation of user seek records that is considered to form a scene. This is an example of the first margin, or the second margin. That is, the first margin may be equal to the second margin, in some examples. To understand the concept of scene_margin, it may be considered that every scene may have a starting point and an ending point in the timeline. It is likely that a new user, may play/stop a bit before or after the starting and/or ending point of a previously determined scene. If the absolute value of the moment the user started or ended the playback, minus the starting or ending point of the scene in timeline, respectively, is within the scene_margin, this means that this user record may be added to the interesting timeline.

Subsequently, the first node 101 may iterate seek records per user of the at least one second user. Every seek record in this particular non-limiting example has the following information:
userID identifying the user who did the seek
mediaID identifying the media the user performed seek on
seek_start, the moment in the media timeline where the user started playback, that is, the first point in time (e.g. 18:20 MM:SS mark)
seek_to, the moment in the media timeline where the user sought to, that is, the second point in time (e.g. 18:22 MM:SS mark)
demographics: the demographics of his user; examples illustrated in this example are the age, location, hobbies and occupation

The first node 101, as part of Action 203, may compare the duration the user spent on watching the digital media content, e.g., a movie, from the point they started playback (seek_start) with a threshold value, the first threshold. If it is greater than the threshold value, this means that the user found this segment of the media interesting. This threshold value may vary. For example, for a video clip it may be a few seconds but for a movie, talk show or newscast it may extend to minutes.

If a playback is interesting, then the first node 10 may retrieve the beginning and ending point of the interesting playback, which would be the difference between seek_start and seek_to. In other words, the first node 101 may start by checking if the duration of time between the first point in time and the second point in time is above the first threshold, and/or if the respective duration of time between the respective first point in time and the respective second point in time is above the first threshold, respectively, for the at least one second user. If so, the first node 101 may store the collected data for this playback as a so called “interesting timeline”, to which successive playbacks may be added, if their duration is above the first threshold. In other words, the “interesting timeline” for a user may be considered a subset of the timeline, wherein the duration of the playbacks is above the first threshold, for a particular digital media content.

Subsequently, the first node 101 compares the demographics of the user of the seek record against the filter specified, in case the filter was used as input, as detailed in FIG. 7. The comparison may be done for example according to Table 1.

If demographics check out, the <seek_start, seek_to> tuple and the userid, and optionally mediaID, may be stored in an interesting timeline list.

then the algorithm pseudocode may be as such:

for every distinct user id in S, i.e. useridₖ, 1 ≤ k ≤ u

get all seek records for useridₖ in S for mediaID (if mediaID is specified), i.e. Sₖ∩
S: ∀ sₘ(useridₘ,..) ∈ Sₖ, useridₘ = useridₖ , where s(m) is a seek record in S(K)

from all seek records with seek_toₓ − seek_startₓ time greater than threshold,
the “interesting” timeline as defined above for the user is Tₘ = seek_toₘ −
seek_startₘ
(optional step, if filter and demographics apply) make sure that the
demographics or useridk are what is requested.
Add Tₘ to interesting timelines group T, together with useridₖ and optionally
mediaid

loop until all users u are scanned
for every distinct user id in S, i.e. useridₖ, 1 ≤ k ≤ u

Once interesting timeline lists from all users of the at least one second user may have been computed, then the first node 101 may iterate the interesting timeline lists and compute scenes according to Action 202. The first node 101 may go over the interesting timelines, and check whether they may be grouped into scenes, by checking if there are playbacks that start around the same time and end around the same time for the users.

Scene computation may be based on comparing the seek_start and seek_to of the interesting timeline list record with every other record's seek_start and seek_to, respectively. If the comparison is below or equal to a margin, e.g., the first margin and the second margin, then this is classified as a scene, that is, determined to be a scene, and is recorded in a scene array. A scene array may be understood as the collection of playbacks for all users whose respective first point in time and respective second point in time fall within the first and second margin, respectively.

The beginning and the ending of the scene may be understood as the current values of the scene array, aggregated by the beginning and ending point of the scene of the interesting timeline respectively, divided by two, that is, an average which is computed pair by pair of interesting playbacks at a time, during the iteration of all records. In some examples, the beginning point of the scene may be computed as an average of all the respective first points in time within the first margin. The ending point of the scene may be computed as an average of all the respective second points in time within the second margin.

For every computation of the average, the first node 101 may add a count to the scene array for the scene in question and it makes sure that it does not log double records into the scene array.

This is reflected in an example as follows:

```
Given w interesting timelines in T{t₁, . . . t_{w}}, then for every tₓ
(scene_beginₓ, scene_endₓ) in T, compose scene array S{(scene_beginₛ,
scene_endₛ), usercount, medial D(optional)} of interesting Scenes
      For every other timeline in T, t_{y}, if | scene_beginₓ₋ scene_begin_{y} | ≤
      scene_margin AND | scene_endₓ₋ scene_end_{y} | scene_margin, then
        (Optionally: Get Scene Array S for media ID)
        If record within margins already exists in Scene array S,
          If comparison between tₓ and t_{y} is not already
          accounted for
              Increment record counter by one
              Recompute scene_beginₛ, scene_endₛ:
            ${scene\_begin}_{sNEW} = \frac{{scene\_begin}_{s} + {scene\_begin}_{y}}{2}$
            ${scene\_end}_{sNEW} = \frac{{scene\_end}_{s} + {scene\_end}_{y}}{2}$
        Else add record to Scene array S with record counter one and:
          scene_beginₛ= scene_begin_{y}
          scene_endₛ= scene_end_{y}
    Loop
  Loop
Loop
Return S
```

According to Action 204, the first node 101 may then provide the first indication to the requesting MIR as the final scene array.

The accuracy of the determination of the segment in Action 203 and the determination of the scene in Action 202 may increase over time, as more and more user seek behaviors are captured and stored in the RSBS.

Content Delivery Network (CDN) and MIR

In some examples, a CDN may query interesting scene information from a MIR. As an example of the third indication of Action 402, the response may be described in MPEG 7 (ISO 15938) format. The following XML snippet is an indication of how that information may be represented:

<Media id=”iuadsa2=98dsadaj”>
<VideoSegment id=″VS1″>

<MediaTime>

<MediaTimePoint>T0:0:0</MediaTimePoint>
<MediaDuration>PT10M</MediaDuration>

</MediaTime>
<StructuredAnnotation>

This is a very interesting segment

</StructuredAnnotation>

</VideoSegment>
<Media>

A CDN node may either request this information directly from the MIR or the MIR may proactively send this information.

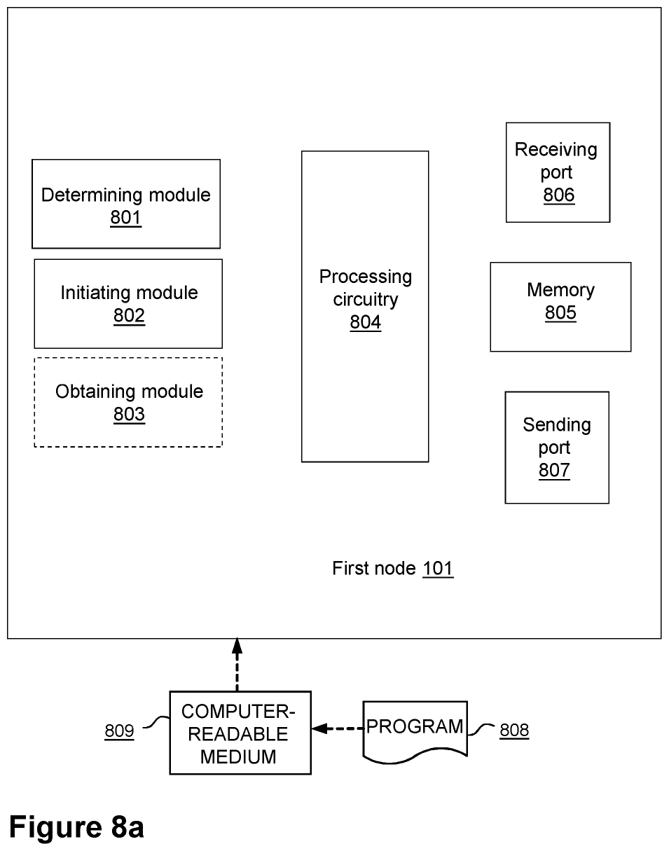

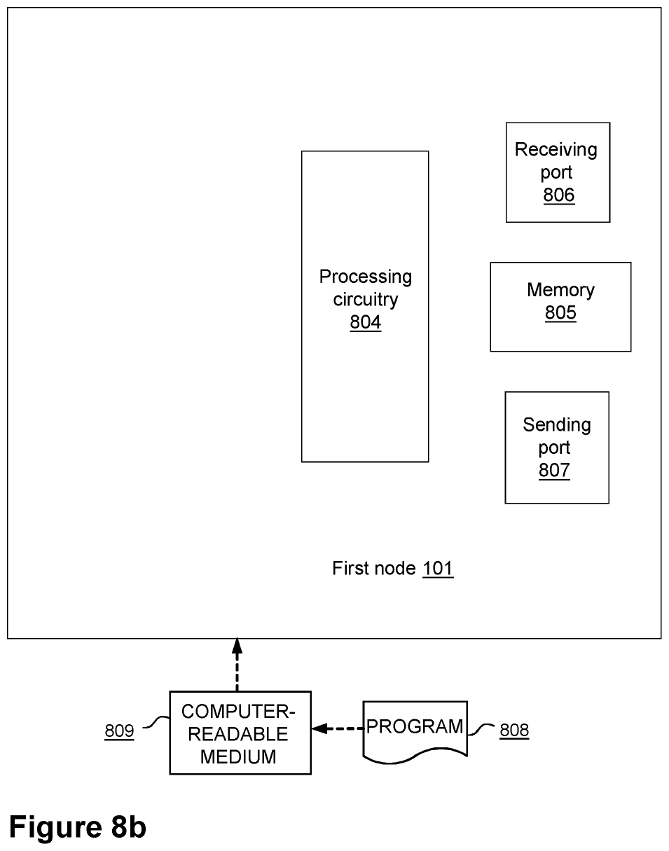

To perform the method actions described above in relation to FIG. 2, FIG. 5 and FIG. 7, the first node 101, configured to handle the digital media content may comprise the following arrangement depicted in FIG. 8a. As stated earlier, the first node 101 is configured to be comprised in the computer system 10.

Note that in the description of any of the first node 101, the second node 102 and the third node 103, in respect to any of FIG. 8a-FIG. 10b, the term user, in singular or plural, refers to a computer code for such user or users.

The detailed description of some of the following corresponds to the same references provided above, in relation to the actions described for the first node 101, and will thus not be repeated here. For example, the digital media content comprises at least one of: digital audio and digital video.

It should be noted that the examples herein are not mutually exclusive. Components from one example may be tacitly assumed to be present in another example and it will be obvious to a person skilled in the art how those components may be used in the other examples.

The first node 101 is further configured to, e.g., by means of a determining module 801 configured to, determine, automatically, the segment of the digital media content to be of interest to the first user of a second node 102. The second node 102 is configured to provide the digital media content to the first user and to be comprised in the computer system 10. To determine is configured to be based on the analysis of data configured to be collected, on seeking of the digital media content by the at least one second user. The seeking is configured to have been performed in points in time in the digital media content. The points in time are configured to have been freely chosen by the least one second user from the entire duration of the digital media content.

The at least one second user may be configured to comprise at least one of: the first user, and another one or more users being configured to have played back the digital media content.

To determine may be configured to be performed based on a request configured to be received from at least one of: the second node 102 and the third node 103.

In some embodiments, the data configured to be collected may be configured to comprise at least one of the following options. In the first option, a) the first point in time the playback of the digital media content by the first user is configured to have started, at the earlier occasion, wherein the first point in time is configured to have been freely chosen by the first user from the entire duration of the digital media content; and the second point in time the playback of the digital media content by the first user is configured to have ended at the earlier occasion, wherein the second point in time is configured to have been freely chosen by the user. In the second option, b) the number of times the playback is configured to have been played by the first user, wherein every playback is configured to have been counted, based on a first margin of the first point in time and a second margin of the second point in time from the entire duration of the digital media content. The segment of the digital media content may be configured to be determined to be of interest to the first user based on whether at least one of: i) the duration of time between the first time point and the second time point is above the first threshold, and ii) the number of times the playback is configured to have been played by the first user is above the second threshold.

In some embodiments, the data configured to be collected may comprise at least one of the two following options, for a respective playback for each of the another one or more users. In a first option, the data configured to be collected may comprise a) the respective first point in time the respective playback of the digital media content by the respective first user of the another one or more users is configured to have started, at the respective earlier occasion, wherein the respective first point in time is configured to have been freely chosen by the respective first user of the another one or more users from the entire duration of the digital media content; and in the first option, the data configured to be collected may also comprise the respective second point in time the respective playback of the digital media content by the respective first user of the another one or more users is configured to have ended at the respective earlier occasion, wherein the respective second point in time is configured to have been freely chosen by the respective first user of the another one or more users from the entire duration of the digital media content In a second option, the data configured to be collected may comprise b) the respective number of times the respective playback is configured to have been played by the respective first user of the another one or more users, wherein every playback is configured to have been counted, based on the first margin of the first point in time and the second margin of the second point in time. The segment of the digital media content may be configured to be determined to be of interest to the first user based on whether at least one of: i) the respective duration of time between the respective first time point and the respective second time point is above the first threshold, respectively, for the another one or more users, and ii) the respective number of times the respective playback is configured to have been played is above the second threshold, respectively, for the another one or more users.

The first node 101 is further configured to, e.g., by means of an initiating module 802 configured to, initiate providing the first indication of the segment of the digital media content configured to be determined to be of interest to the first user, to at least one of: the second node 102, and the another node 103, 104 configured to be comprised in the computer system 10.

In some embodiments, the first node 101 may be further configured to, e.g., by means of the determining module 801 further configured to, determine the scene in the digital media content, based on whether the respective duration of time between the respective first time point and the respective second time point may be above the first threshold, respectively, for the another one or more users, for at least two playbacks. To determine the segment of the digital media content to be of interest to the first user may be further configured to be based on a comparison of the segment of the digital media content with the scene.

In some embodiments, to determine the segment of the digital media content to be of interest to the first user may be further configured to be based on demographic data of the first user. The segment of the digital media content may be determined to be of interest to the first user based on whether or not the demographic data of the first user match a set of demographic data configured to be mapped to the segment. The set of demographic data configured to be mapped to the segment may be based on the data configured to be collected on seeking of the digital media content by the another one or more users.

The first node 101 may be further configured to, e.g., by means of an obtaining module 803 configured to, obtain the data configured to be collected from at least one of: the first node 101, the second node 102, and another node 103, 104 configured to be comprised in the computer system 10.

The embodiments herein may be implemented through one or more processors, such as a processing circuitry 804 in the first node 101 depicted in FIG. 8a, together with computer program code for performing the functions and actions of the embodiments herein. The processing circuitry 804 may be understood herein as a hardware component of the first node 101. The program code mentioned above may also be provided as a computer program product, for instance in the form of a data carrier carrying computer program code for performing the embodiments herein when being loaded into the in the first node 101. One such carrier may be in the form of a CD ROM disc. It is however feasible with other data carriers such as a memory stick. The computer program code may furthermore be provided as pure program code on a server and downloaded to the first node 101.

The first node 101 may further comprise a memory 805 comprising one or more memory units. The memory 805 is arranged to be used to store obtained information, store data, configurations, and applications etc. to perform the methods herein when being executed in the first node 101.

In some embodiments, the first node 101 may receive information from the second node 102, the third node 103, the fourth node 104, another node and/or any of the pertinent databases described above, through a receiving port 806. In some examples, the receiving port 806 may be, for example, connected to one or more antennas in first node 101. In other embodiments, the first node 101 may receive information from another structure in the computer system 10 through the receiving port 806. Since the receiving port 806 may be in communication with the processing circuitry 804, the receiving port 806 may then send the received information to the processing circuitry 804. The receiving port 806 may also be configured to receive other information from other communication devices or structures in the computer system 10.

The processing circuitry 804 in the first node 101 may be further configured to transmit or send information to e.g., the second node 102, the third node 103, the fourth node 104, another node and/or any of the pertinent databases described above, through a sending port 807, which may be in communication with the processing circuitry 804, and the memory 805.

Those skilled in the art will also appreciate that the determining module 801, the initiating module 802, and the obtaining module 803 described above may refer to a combination of analog and digital modules, and/or one or more processors configured with software and/or firmware, e.g., stored in memory, that, when executed by the one or more processors, such as the processing circuitry 804, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 801-803 described above may be implemented as one or more applications running on one or more processors such as the processing circuitry 804.

Thus, the methods according to the embodiments described herein for the first node 101 may be respectively implemented by means of a computer program 808 product, comprising instructions, i.e., software code portions, which, when executed on at least one processing circuitry 804, cause the at least one processing circuitry 804 to carry out the action described herein, as performed by the first node 101. The computer program 808 product may be stored on a computer-readable storage medium 809. The computer-readable storage medium 809, having stored thereon the computer program 808, may comprise instructions which, when executed on at least one processing circuitry 804, cause the at least one processing circuitry 804 to carry out the action described herein, as performed by the first node 101. In some embodiments, the computer-readable storage medium 809 may be a non-transitory computer-readable storage medium, such as a CD ROM disc, or a memory stick. In other embodiments, the computer program 808 product may be stored on a carrier containing the computer program 808 just described, wherein the carrier is one of an electronic signal, optical signal, radio signal, or the computer-readable storage medium 809, as described above.

In other examples, to perform the method actions described above in relation to FIG. 2, the first node 101 may comprise the arrangement depicted in FIG. 8b. The first node 101 may comprise the processing circuitry 804, in the first node 101, the memory 805, the receiving port 806, the sending port 807, the program 808 and the computer-readable medium 809. The memory 805 may comprise instructions executable by the processing circuitry 804 whereby the first node 101 may be configured to perform one or more of the method actions according to FIG. 2.

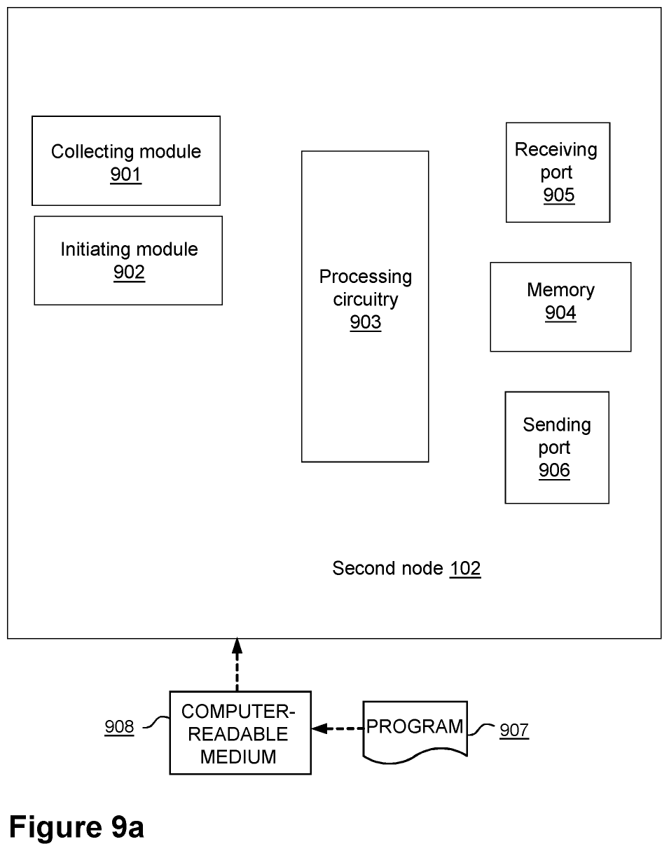

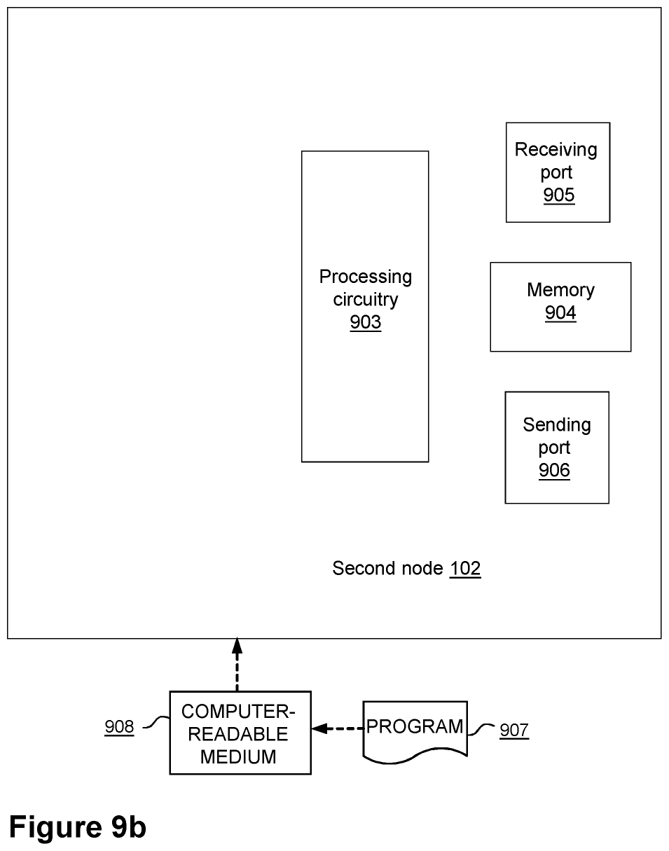

To perform the method actions described above in relation to FIG. 2, FIG. 5 or FIG. 7, the second node 102, configured to handle a digital media content, may comprise the following arrangement depicted in FIG. 9a. As stated earlier, the second node 102 is configured to be comprised in the computer system 10.

The detailed description of some of the following corresponds to the same references provided above, in relation to the actions described for the second node 102, and will thus not be repeated here. For example, the digital media content comprises at least one of: digital audio and digital video.

It should be noted that the examples herein are not mutually exclusive. Components from one example may be tacitly assumed to be present in another example and it will be obvious to a person skilled in the art how those components may be used in the other examples.

The second node 102 is configured to, e.g., by means of a collecting module 901 configured to, collect the data from the first user of the second node 102 on seeking the digital media content. The data comprises: a) the first point in time the playback of the digital media content by the first user is configured to have started, wherein the first point in time is configured to have been freely chosen by the first user from the entire duration of the digital media content; and b) the second point in time the playback of the digital media content by the first user is configured to have ended, wherein the second point in time is configured to have been freely chosen by the first user from the entire duration of the digital media content.

In some embodiments, the data configured to be collected may further comprise the number of times the playback may be configured to have been played by the first user. Every playback may be configured to have been counted, based on the first margin of the first point in time and the second margin of the second point in time.

In some embodiments, to collect the data may be configured to be performed for the at least one second user comprising the another one or more users configured to have played back the digital media content. The data configured to be collected may comprises at least one of the following two options a) and b), for a respective playback for each of the another one or more users. In the first option a), the data configured to be collected may comprise the respective first point in time the respective playback of the digital media content by the respective first user of the another one or more users is configured to have started, at the respective occasion, wherein the respective first point in time is configured to have been freely chosen by the respective first user of the another one or more users from the entire duration of the digital media content. In the first option a), the data configured to be collected may also comprise the respective second point in time the respective playback of the digital media content by the respective first user of the another one or more users is configured to have ended at the respective earlier occasion, wherein the respective second point in time is configured to have been freely chosen by the respective first user of the another one or more users from the entire duration of the digital media content. In the second option b), the data configured to be collected may comprise the respective number of times the respective playback may be configured to have been played by the respective first user of the another one or more users, wherein every playback may be configured to have been counted, based on the first margin of the first point in time and the second margin of the second point in time.

The second node 102 is further configured to, e.g., by means of an initiating module 902 configured to, initiate providing the second indication of the data configured to be collected to at least one of: the first node 101 configured to be comprised in the computer system 10, and the another node 103, 104 configured to be comprised in the computer system 10.

The embodiments herein may be implemented through one or more processors, such as a processing circuitry 903 in the second node 102 depicted in FIG. 9a, together with computer program code for performing the functions and actions of the embodiments herein. The processing circuitry 903 may be understood herein as a hardware component of the second node 102. The program code mentioned above may also be provided as a computer program product, for instance in the form of a data carrier carrying computer program code for performing the embodiments herein when being loaded into the in the second node 102. One such carrier may be in the form of a CD ROM disc. It is however feasible with other data carriers such as a memory stick. The computer program code may furthermore be provided as pure program code on a server and downloaded to the second node 102.

The second node 102 may further comprise a memory 904 comprising one or more memory units. The memory 904 is arranged to be used to store obtained information, store data, configurations, schedulings, and applications etc. to perform the methods herein when being executed in the second node 102.

In some embodiments, the second node 102 may receive information from the first node 101, the third node 103, the fourth node 104, another node, and/or any of the pertinent databases described above, through a receiving port 905. In some examples, the receiving port 905 may be, for example, connected to one or more antennas in second node 102. In other embodiments, the second node 102 may receive information from another structure in the computer system 10 through the receiving port 905. Since the receiving port 905 may be in communication with the processing circuitry 903, the receiving port 905 may then send the received information to the processing circuitry 903. The receiving port 905 may also be configured to receive other information.

The processing circuitry 903 in the second node 102 may be further configured to transmit or send information to e.g., the first node 101, the third node 103, the fourth node 104, another node, and/or any of the pertinent databases described above, through a sending port 906, which may be in communication with the processing circuitry 903, and the memory 904.

Those skilled in the art will also appreciate that the collecting module 901 and the initiating module 902 described above may refer to a combination of analog and digital modules, and/or one or more processors configured with software and/or firmware, e.g., stored in memory, that, when executed by the one or more processors such as the processing circuitry 903, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 901-902 described above may be implemented as one or more applications running on one or more processors such as the processing circuitry 903.

Thus, the methods according to the embodiments described herein for the second node 102 may be respectively implemented by means of a computer program 907 product, comprising instructions, i.e., software code portions, which, when executed on at least one processing circuitry 903, cause the at least one processing circuitry 903 to carry out the action described herein, as performed by the second node 102. The computer program 907 product may be stored on a computer-readable storage medium 908. The computer-readable storage medium 908, having stored thereon the computer program 907, may comprise instructions which, when executed on at least one processing circuitry 903, cause the at least one processing circuitry 903 to carry out the action described herein, as performed by the second node 102. In some embodiments, the computer-readable storage medium 908 may be a non-transitory computer-readable storage medium 908, such as a CD ROM disc, or a memory stick. In other embodiments, the computer program 907 product may be stored on a carrier containing the computer program 907 just described, wherein the carrier is one of an electronic signal, optical signal, radio signal, or the computer-readable storage medium 908, as described above.

In other examples, to perform the method actions described above in relation to FIG. 3, the second node 102 may comprise the following arrangement depicted in FIG. 8b. The second node 102 may comprise the processing circuitry 903, in the second node 102, the memory 904, the receiving port 905, the sending port 906, the program 907 and the computer-readable medium 908. The memory 904 may comprise instructions executable by the processing circuitry 903 whereby the second node 102 may be configured to perform one or more of the method actions according to FIG. 3.

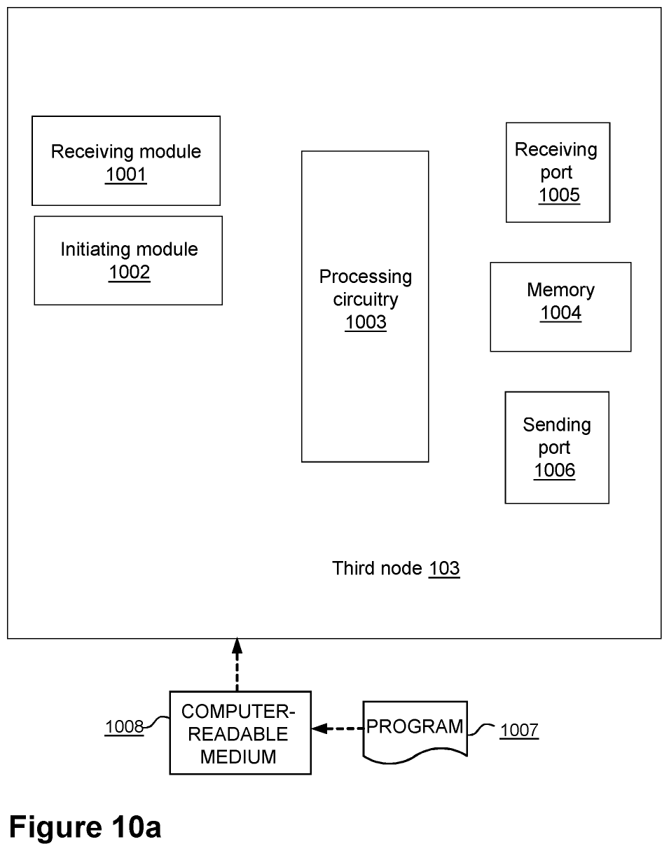

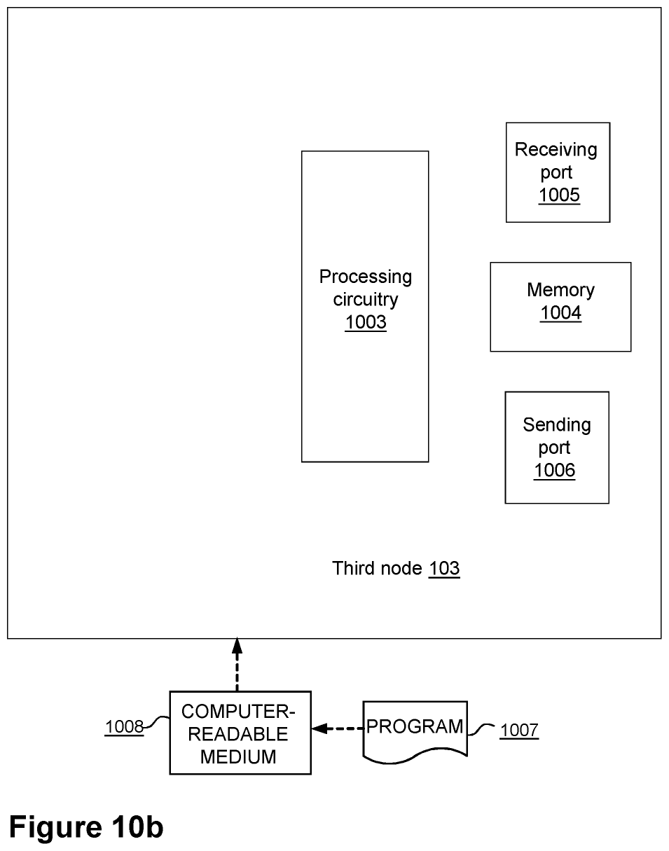

To perform the method actions described above in relation to FIG. 4, the third node 103, configured to handle the digital media content, may comprise the following arrangement depicted in FIG. 10a. As stated earlier, the third node 103 is further configured to be comprised in the computer system 10.

The detailed description of some of the following corresponds to the same references provided above, in relation to the actions described for the third node 103, and will thus not be repeated here. For example, the digital media content comprises at least one of: digital audio and digital video.

It should be noted that the examples herein are not mutually exclusive. Components from one example may be tacitly assumed to be present in another example and it will be obvious to a person skilled in the art how those components may be used in the other examples.

The third node 103 is configured to, e.g., by means of a receiving module 1001 configured to, receive, from the first node 101 configured to be comprised in the computer system 10, the first indication of the segment of a digital media content configured to be determined to be of interest to the first user of the second node 102. The second node 102 is configured to provide the digital media content to the first user and to be comprised in the computer system 10. The segment of the digital media content is configured to have been determined to be of interest based on the analysis of data configured to be collected on seeking of the digital media content by the at least one second user, the points in time being configured to have been chosen by the least one second user, from the entire duration of the digital media content.

The at least one second user may comprise at least one of: the first user, and the another one or more users configured to have played back the digital media content.

The third node 103 is further configured to, e.g., by means of an initiating module 1002 configured to, initiate providing, on the interface 105 of the third node 103, the third indication of the segment of the digital media content determined to be of interest to the first user, based on the first indication configured to be received.

The embodiments herein may be implemented through one or more processors, such as a processing circuitry 1003 in the third node 103 depicted in FIG. 9a together with computer program code for performing the functions and actions of the embodiments herein. The processing circuitry 1003 may be understood herein as a hardware component of the third node 103. The program code mentioned above may also be provided as a computer program product, for instance in the form of a data carrier carrying computer program code for performing the embodiments herein when being loaded into the in the third node 103. One such carrier may be in the form of a CD ROM disc. It is however feasible with other data carriers such as a memory stick. The computer program code may furthermore be provided as pure program code on a server and downloaded to the third node 103.

The third node 103 may further comprise a memory 1004 comprising one or more memory units. The memory 1004 is arranged to be used to store obtained information, store data, configurations, schedulings, and applications etc. . . . to perform the methods herein when being executed in the third node 103.

In some embodiments, the third node 103 may receive information from the first node 101, the second node 102, the fourth node 104, another node, and/or any of the pertinent databases described above, through a receiving port 1005. In some examples, the receiving port 1005 may be, for example, connected to one or more antennas in third node 103. In other embodiments, the third node 103 may receive information from another structure in the computer system 10 through the receiving port 1005. Since the receiving port 1005 may be in communication with the processing circuitry 1003, the receiving port 1005 may then send the received information to the processing circuitry 1003. The receiving port 1005 may also be configured to receive other information.

The processing circuitry 1003 in the second node 102 may be further configured to transmit or send information to e.g., first node 101, the third node 103, the fourth node 104, another node, and/or any of the pertinent databases described above, through a sending port 1006, which may be in communication with the processing circuitry 1003, and the memory 1004.

Those skilled in the art will also appreciate that the receiving module 1001, and the initiating module 1002 described above may refer to a combination of analog and digital modules, and/or one or more processors configured with software and/or firmware, e.g., stored in memory, that, when executed by the one or more processors such as the processing circuitry 1003, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

Also, in some embodiments, the different modules 1001-1002 described above may be implemented as one or more applications running on one or more processors such as the processing circuitry 1003.

Thus, the methods according to the embodiments described herein for the third node 103 may be respectively implemented by means of a computer program 1007 product, comprising instructions, i.e., software code portions, which, when executed on at least one processing circuitry 1003, cause the at least one processing circuitry 1003 to carry out the action described herein, as performed by the third node 103. The computer program 1007 product may be stored on a computer-readable storage medium 1008. The computer-readable storage medium 1008, having stored thereon the computer program 1007, may comprise instructions which, when executed on at least one processing circuitry 1003, cause the at least one processing circuitry 1003 to carry out the actions described herein, as performed by the third node 103. In some embodiments, the computer-readable storage medium 1008 may be a non-transitory computer-readable storage medium 1008, such as a CD ROM disc, or a memory stick. In other embodiments, the computer program 1007 product may be stored on a carrier containing the computer program 1007 just described, wherein the carrier is one of an electronic signal, optical signal, radio signal, or the computer-readable storage medium 1008, as described above.

In other examples, to perform the method actions described above in relation to FIG. 4, the third node 103 may comprise the following arrangement depicted in FIG. 10b. The third node 103 may comprise the processing circuitry 1003, in the third node 103, the memory 1004, the receiving port 1006, the sending port 1005, the program 1007 and the computer-readable medium 1008. The memory 1004 may comprise instructions executable by the processing circuitry 1003 whereby the third node 103 may be configured to perform one or more of the method actions according to FIG. 4.

According to the foregoing, some examples of embodiments herein may also comprise a carrier comprising any of the first indication, the second indication and the third indication, as respectively described above, wherein the carrier is one of an electronic signal, optical signal, radio signal, or computer readable storage medium.

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention.

### REFERENCES

1. ID3 tag version 2—http://id3.org/id3v2-00
2. Avishai Hendel, Daphna Weinshall, Shmuel Peleg, “Identifying Surprising Events in Video Using Bayesian Topic Models” in Detection and Identification of Rare Audiovisual Cues, Volume 384 of the series Studies in Computational Intelligence, Springer 2012, pp 97-105
3. Interesting region detection in aerial video using Bayesian topic models. J. Wang, Y. Wang, and Z. Zhang. ACPR, page 706-710. IEEE, (2011)
4. Kuan-Ting Lai, Dong Liu, Ming-Syan Chen and Shih-Fu Chang, “Recognizing Complex Events in Videos by Learning Key Static-Dynamic Evidences”, in Computer Vision—ECCV 2014Volume 8691 of the series Lecture Notes in Computer Science pp 675-688, http://dvmmweb.cs.columbia.edu/files/key%20evidence.pdf

1. A method, performed by a first node, for handling a digital media content, the digital media content comprising at least one of: digital audio and digital video, the first node being comprised in a computer system, the method comprising:
determining, automatically, a segment of the digital media content to be of interest to a first user of a second node providing the digital media content to the first user, the second node being comprised in the computer system, the determining being based on an analysis of collected data on seeking of the digital media content by at least one second user, the seeking having been performed in points in time in the digital media content, the points in time having been freely chosen by the least one second user from an entire duration of the digital media content, and
initiating providing a first indication of the determined segment of the digital media content to be of interest to the first user, to at least one of: the second node, and another node comprised in the computer system.

2. The method of claim 1, wherein the at least one second user comprises at least one of: the first user, and another one or more users having played back the digital media content.

3. The method of claim 2, wherein the collected data comprises at least one of:
a) a first point in time a playback of the digital media content by the first user started, at an earlier occasion, wherein the first point in time was freely chosen by the first user from the entire duration of the digital media content; and
a second point in time the playback of the digital media content by the first user ended at the earlier occasion, wherein the second point in time was freely chosen by the user; and
b) a number of times the playback was played by the first user, wherein every playback was counted, based on a first margin of the first point in time and a second margin of the second point in time from the entire duration of the digital media content, and
wherein the segment of the digital media content is determined to be of interest to the first user based on whether at least one of:
i) a duration of time between the first time point and the second time point is above a first threshold, and
ii) the number of times the playback was played by the first user is above a second threshold.

4. The method of claim 2, wherein the collected data comprises at least one of, for a respective playback for each of the another one or more users:
a) a respective first point in time the respective playback of the digital media content by a respective first user of the another one or more users started, at a respective earlier occasion, wherein the respective first point in time was freely chosen by the respective first user of the another one or more users from the entire duration of the digital media content;
a respective second point in time the respective playback of the digital media content by the respective first user of the another one or more users ended at the respective earlier occasion, wherein the respective second point in time was freely chosen by the respective first user of the another one or more users from the entire duration of the digital media content; and
b) a respective number of times the respective playback was played by the respective first user of the another one or more users, wherein every playback was counted, based on the first margin of the first point in time and the second margin of the second point in time, and
wherein the segment of the digital media content is determined to be of interest to the first user based on whether at least one of:
i) a respective duration of time between the respective first time point and the respective second time point is above a first threshold, respectively, for the another one or more users, and
ii) the respective number of times the respective playback was played is above a second threshold, respectively, for the another one or more users.

5. The method of claim 4, wherein, the method further comprising:
determining a scene in the digital media content, based on whether the respective duration of time between the respective first time point and the respective second time point is above the first threshold, respectively, for the another one or more users for at least two playbacks, and wherein the determining the segment of the digital media content to be of interest to the first user is further based on a comparison of the segment of the digital media content with the scene.

6. The method of claim 3, wherein the determining the segment of the digital media content to be of interest to the first user is further based on demographic data of the first user, wherein the segment of the digital media content is determined to be of interest to the first user based on whether or not the demographic data of the first user match a set of demographic data mapped to the segment, the set of demographic data mapped to the segment being based on the collected data on seeking of the digital media content by the another one or more users.

7. The method of claim 1, wherein the determining is performed based on a request received from at least one of: the second node and the third node.

8. The method of claim 1, the method further comprising:
obtaining the collected data from at least one of: the first node, the second node, and another node comprised in the computer system.

9. A computer program product comprising a non-transitory computer readable medium storing a computer program, comprising instructions which, when executed on at least one processor, cause the at least one processor to carry out the method of claim 1.

10. (canceled)

11. A method, performed by a second node, for handling a digital media content, the digital media content comprising at least one of: digital audio and digital video, the second node being comprised in a computer system, the method comprising:
collecting data from a first user of the second node on seeking the digital media content, the data comprising:
a) a first point in time a playback of the digital media content by the first user started, wherein the first point in time was freely chosen by the first user from an entire duration of the digital media content; and
b) a second point in time the playback of the digital media content by the first user ended, wherein the second point in time was freely chosen by the first user from the entire duration of the digital media content; and
initiating providing a second indication of the collected data to at least one of: the first node comprised in the computer system, and another node comprised in the computer system.

12. The method of claim 11, wherein the collected data further comprises:
a number of times the playback was played by the first user, wherein every playback was counted, based on a first margin of the first point in time and a second margin of the second point in time.

13. The method of claim 11, wherein the collecting of the data is performed for at least one second user comprising another one or more users having played back the digital media content, and wherein the collected data comprises at least one of, for a respective playback for each of the another one or more users:
a) a respective first point in time the respective playback of the digital media content by a respective first user of the another one or more users started, at a respective occasion, wherein the respective first point in time was freely chosen by the respective first user of the another one or more users from the entire duration of the digital media content;
a respective second point in time the respective playback of the digital media content by the respective first user of the another one or more users ended at the respective earlier occasion, wherein the respective second point in time was freely chosen by the respective first user of the another one or more users from the entire duration of the digital media content; and
b) a respective number of times the respective playback was played by the respective first user of the another one or more users, wherein every playback was counted, based on the first margin of the first point in time and the second margin of the second point in time.

14. A computer program product comprising a non-transitory computer readable medium storing a computer program, comprising instructions which, when executed on at least one processor, cause the at least one processor to carry out the method of claim 11.

15. (canceled)

16. A method, performed by a third node, for handling a digital media content, the digital media content comprising at least one of: digital audio and digital video, the third node being comprised in a computer system, the method comprising:
receiving, from the first node comprised in the computer system, a first indication of a segment of a digital media content determined to be of interest to a first user of a second node providing the digital media content to the first user, the second node being comprised in the computer system, wherein the segment of the digital media content has been determined to be of interest based on an analysis of collected data on seeking of the digital media content by at least one second user, the points in time being freely chosen by the least one second user, from an entire duration of the digital media content, and
initiating providing, on an interface of the third node, a third indication of the segment of the digital media content determined to be of interest to the first user, based on the received first indication.

17. The method of claim 16, wherein the at least one second user comprises at least one of: the first user, and another one or more users having played back the digital media content.

18. A computer program product comprising a non-transitory computer readable medium storing a computer program, comprising instructions which, when executed on at least one processor, cause the at least one processor to carry out the method of claim 16.

19. (canceled)

20. A first node configured to handle a digital media content, the digital media content comprising at least one of: digital audio and digital video, the first node being configured to be comprised in a computer system, the first node being further configured to:
determine, automatically, a segment of the digital media content to be of interest to a first user of a second node, the second node being configured to provide the digital media content to the first user and to be comprised in the computer system, wherein to determine is configured to be based on an analysis of data configured to be collected, on seeking of the digital media content by at least one second user, the seeking being configured to have been performed in points in time in the digital media content, the points in time being configured to have been freely chosen by the least one second user from an entire duration of the digital media content, and
initiate providing a first indication of the segment of the digital media content configured to be determined to be of interest to the first user, to at least one of: the second node, and another node configured to be comprised in the computer system.

21. The first node of claim 20, wherein the at least one second user is configured to comprise at least one of: the first user, and another one or more users being configured to have played back the digital media content.

22. The first node of claim 21, wherein the data configured to be collected is configured to comprise at least one of:
a) a first point in time a playback of the digital media content by the first user is configured to have started, at an earlier occasion, wherein the first point in time is configured to have been freely chosen by the first user from the entire duration of the digital media content; and
a second point in time the playback of the digital media content by the first user is configured to have ended at the earlier occasion, wherein the second point in time is configured to have been freely chosen by the user; and
b) a number of times the playback is configured to have been played by the first user, wherein every playback is configured to have been counted, based on a first margin of the first point in time and a second margin of the second point in time from the entire duration of the digital media content, and
wherein the segment of the digital media content is configured to be determined to be of interest to the first user based on whether at least one of:
i) a duration of time between the first time point and the second time point is above a first threshold, and
ii) the number of times the playback is configured to have been played by the first user is above a second threshold.

23. The first node of claim 21, wherein the data configured to be collected comprises at least one of, for a respective playback for each of the another one or more users:
a) a respective first point in time the respective playback of the digital media content by a respective first user of the another one or more users is configured to have started, at a respective earlier occasion, wherein the respective first point in time is configured to have been freely chosen by the respective first user of the another one or more users from the entire duration of the digital media content;
a respective second point in time the respective playback of the digital media content by the respective first user of the another one or more users is configured to have ended at the respective earlier occasion, wherein the respective second point in time is configured to have been freely chosen by the respective first user of the another one or more users from the entire duration of the digital media content; and
b) a respective number of times the respective playback is configured to have been played by the respective first user of the another one or more users, wherein every playback is configured to have been counted, based on the first margin of the first point in time and the second margin of the second point in time, and
wherein the segment of the digital media content is configured to be determined to be of interest to the first user based on whether at least one of:
i) a respective duration of time between the respective first time point and the respective second time point is above a first threshold, respectively, for the another one or more users, and
ii) the respective number of times the respective playback is configured to have been played is above a second threshold, respectively, for the another one or more users.

24-32. (canceled)
